(19) United States
(12) Patent Application Publication
(10) Pub. No.: US 2014/0106967 A1
(43) Pub. Date: Apr. 17, 2014

(54) AUXIN PLANT GROWTH REGULATORS

(71) Applicants: Jocelyn Ozga, Edmonton (CA); Dennis Reinecke, Edmonton (CA)

(72) Inventors: Jocelyn Ozga, Edmonton (CA); Dennis Reinecke, Edmonton (CA)

(73) Assignee: The Governors of The University of Alberta

(21) Appl. No.: 14/005,905

(22) PCT Filed: Mar. 21, 2012
(86) PCT No.: PCT/CA2012/000258

§ 371 Date: Dec. 9, 2013

Related U.S. Application Data
(60) Provisional application No. 61/454,813, filed on Mar. 21, 2011.

(51) Int. Cl. A01N 43/38; C05G 3/02; A01N 43/12

(52) U.S. Cl. CPC A01N 43/38; A01N 43/12; C05G 3/02
USPC 504/103; 504/284; 504/138

(57) ABSTRACT

Compositions and methods for enhancing plant growth in a flowering plant having an auxin response pathway by applying an effective amount of a composition comprising an auxin or auxin analog to the plant, or a portion thereof, or a locus thereof, at or before an early reproductive stage of the plant. The enhanced plant growth may ameliorate the effects of abiotic stress and/or improve fruit or seed yield.

### FIELD OF THE INVENTION

The present invention relates to the technical field of agrochemicals and methods used in agriculture for plant growth regulation. In particular, the present invention relates to the use of auxins and auxin-analogs as agrochemicals applied to plants to improve one or more of yield, plant architecture, or plant maturation, and as a strategy to increase yield and prevent or reduce abiotic stress symptoms in reproductive organs of plants.

### BACKGROUND

Plant growth is affected by a variety of physical and chemical factors. Physical factors include available light, day length, moisture and temperature. Chemical factors include minerals, nitrates, cofactors, nutrient substances and plant growth regulators or hormones, for example, auxins, cytokinins and gibberellins. Plant growth regulation relates to a variety of plant responses which improve some characteristic of the plant. “Plant growth regulators” are compounds which possess activity in one or more growth regulation processes of a plant.

Indole-3-acetic acid (IAA) is a naturally-occurring plant growth hormone identified in plants. IAA has been shown to be directly responsible for the increase in growth in plants in vivo and in vitro. The characteristics known to be influenced by IAA include cell elongation, internodal distance (height), and leaf surface area. IAA and other compounds exhibiting hormonal regulatory activity similar to that of IAA are included in a class of plant growth regulators called “auxins.”

Plant growth regulation is a desirable way to improve plants and their cropping so as to obtain improved plant growth and better conditions of agriculture practice. Plant growth regulators identified in plants most often regulate division, elongation and differentiation of plant cells in a way that has multiple effects in plants. The trigger event can be seen to be different in plants in comparison to those known from animals.

On the molecular basis, plant growth regulators may work by affecting membrane properties, controlling gene expression or affecting enzyme activity, or being active in a combination of at least two of the above-mentioned types of interaction. Plant growth regulators are chemicals either of natural origin (also called plant hormones) such as non-peptide hormones (for example auxins, gibberellins, cytokinins, ethylene, brassinosteroids, abscisic acid), fatty acid derivatives (for example jasmonates), and oligosaccharins (see: Biochemistry & Molecular Biology of the Plant (2000); eds. Buchanan, Gruissem, Jones, pp. 558-562; and 850-929), or they can be synthetically produced compounds such as derivatives of naturally occurring plant growth hormones (ethephon).

Plant growth regulators which work at very small concentrations can be found in most plant cells and tissues, depending on the organ and developmental stage of the organ. Beside the selection of a suitable compound, it is also relevant to look for the optimal environmental conditions because there are several factors that may affect the action of growth hormones, for example (a) the concentration of the plant growth regulator itself, (b) the quantity applied to the plant, (c) the time of application in relation to the developmental stage of the plant, (d) temperature and humidity prior to and after treatment, (e) plant moisture content, and several others.

The exact mode of action of existing plant growth regulators is often not known and may depend on the process affected in the plant. Auxins have been implicated in a wide range of functions in plants including cell division, cell elongation, vascular differentiation, root initiation, tropisms, and fruit development (Reinecke, D. M. (1999) 4-Chloroindole-3-acetic acid and plant growth. Plant Growth Regul 27:3-13; Davies P J (2004) The plant hormones: Their nature, occurrence and function. (Davies P J (ed.) Plant Hormones: Biosynthesis, Signal Transduction, Action! 3^{rd} ed. Springer, Dordrecht, The Netherlands, p 1-15)).

An auxin may regulate plant growth by involving an extremely complex cascade of genetic and biochemical events which, for example, can lead to a growth stimulation of one organ or cell type of a plant but also can lead to a repression in other organs or cell type of the same plant.

### SUMMARY OF THE INVENTION

In the context of the present invention, plant growth regulation is distinguished from pesticidal or herbicidal action or growth reduction, which is also sometimes referred to as a plant growth regulation, the intention of which is to inhibit or stunt the growth of a plant. For this reason, the practice of the present invention involve the use of compounds in amounts which are non-phytotoxic with respect to the plant being treated, but which stimulate the growth and/or development of the plant or certain parts thereof, stimulate the natural maturation/senescence phase of the plant life cycle, or protect or reduce abiotic stress symptoms in plants.

Therefore, in one aspect, the invention comprises a method of enhancing plant growth in a flowering plant comprising an auxin response pathway, comprising applying an effective amount of a composition comprising an auxin or auxin analog to the plant, or a portion thereof, or a locus thereof, at or before an early reproductive stage of the plant. The enhanced plant growth may be evidenced by increased fruit retention, increased seed yield, and facilitated plant maturation (dry-down) under abiotic stress and non-stress conditions.

In one embodiment, the auxin or auxin analog is applied at or before anthesis, or least one day or at least two days prior to anthesis, or may be applied at least one week prior to anthesis.

In one embodiment, the auxin or auxin analog comprises a 4-substituted indole-3-acetic acid (4-R-IAA). In one embodiment, the 4-R-IAA may comprise 4-chloro-indole-3-acetic acid, or 4-methyl-indole-3-acetic acid.

The invention may comprise a method of ameliorating the symptoms of abiotic stress in a plant comprising an auxin response pathway, comprising applying an effective amount of a composition comprising an auxin or auxin analog to the plant, or a portion thereof, or a locus thereof, at or before an early reproductive stage of the plant.

The amelioration of abiotic stress symptoms may be seen where the abiotic stress is heat, drought, or salinity, or combinations thereof. In one embodiment, the composition is applied at anthesis, at least one day or at least two days prior to anthesis, or at least one week prior to anthesis.

The invention may comprise a method of increasing fruit or seed yield from a plant, under non-stress or abiotic stress conditions.

### BRIEF DESCRIPTION OF THE DRAWINGS

The drawings are briefly described as follows:

FIG. 1 is an elevated front perspective view of representative plants showing the effect of heat stress on fruit set in pea (Pisum sativum L.). The heat stress treatment of 34° C. air temperature for 6 hours per day between 11:00 and 17:00 hrs for 4 days during the light cycle (the remainder of the light cycle was maintained at a 22° C. air temperature; the dark cycle was maintained at 19° C.) at the time of reproductive development (when the first flowing node was at floral bud or full bloom stage) resulted in flower, fruit and seed abortion that dramatically reduced the number of developing fruit of pea plants.

FIG. 2 is an elevated front perspective view of representative plants showing the effect of 4-ME-IAA treatment on fruit set under heat stress and non-stress (control) conditions. Application of 4-ME-IAA to the plant when the first flowering node was at the floral bud or full bloom stage increased pod retention in pea plants grown under non-stressed conditions and under heat-stress conditions when measured 9-10 days after application.

FIG. 3: Representative plants showing the effect of 4-ME-IAA on plant maturation. The plants in (B) were sprayed to cover with one application of 4-ME-IAA in 0.1% Tween 80 (a nonionic detergent), and those in (A) were sprayed with 0.1% Tween 80 (control treatment). Plants were sprayed when the first flowering node was at floral bud or full bloom, and the pictures were taken 34 days after hormone or control spray application. 4-ME-IAA stimulated maturation of the plant (faster dry-down of plant from the green vegetative state to the yellow dry state).

FIG. 4: Diagram of a treatment plot where the letters represent the replication unit (20 plants with no gaps) within each treatment plot (replication unit, n=8).

FIG. 5: A pea inflorescence with two pods. The position of the lower and upper peduncle and pedicels that attach the pods to the peduncle are shown.

### DETAILED DESCRIPTION OF PREFERRED EMBODIMENTS

The present invention relates to compositions and methods for growth regulation in plants. Any term or expression not expressly defined herein shall have its commonly accepted definition understood by those skilled in the art.

In general terms, said method comprising applying to a plant, or a portion of a plant or the plant's locus, an appropriate amount of a 4-substituted auxin.

As used herein, the term “auxin” shall mean a substance which coordinates or regulates one or more aspects of plant growth. Auxins typically comprise an aromatic ring and a carboxylic acid group. A ubiquitous auxin is indole-3-acetic acid (IAA or IUPAC: 2-(1H-indol-3-yl)acetic acid). An auxin analog may comprise a derivative of IAA, such as those compounds having a substituted moiety (not H) on the 4-position of the indole ring of IAA. Without restriction to a theory, the effectiveness of these 4-substituted IAA appears to depend on the size and conformation of the substituent. Examples include, without limitation, 4-methyl-indole-3-acetic acid (4-Me-IAA) or 4-choroindole-3-acetic acid (4-Cl-IAA), having the formulae shown below and those other derivatives having a substituent on the 4-position, similar in size to a chloro or methyl group:

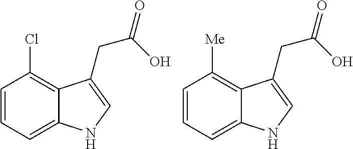

The auxin or auxin analog may comprise a 4-substituted IAA that has been modified at other positions to enhance stability of the auxin response.

The present invention comprises a method of enhancing plant growth by applying a composition comprising an auxin or auxin analog to plants at or before an early reproductive stage of the plant, up to and including anthesis or full bloom. The start of the reproductive stage in any particular plant may be determined anatomically by one skilled in the art. As a result, plant growth, plant yield or plant maturation may improve under non-stress conditions. In one embodiment, the plants may exhibit increased or enhanced tolerance to abiotic stress conditions, such as drought, salinity, or temperature (heat or cold) stress. In one embodiment, the time of application may be days or weeks prior to anthesis or full bloom.

In specific embodiments, the methods and compositions described herein may be used to enhance plant growth in various flowering plants (Angiospermae) with economic value, such as banana; cereal grains, such as barley, buckwheat, canola, corn, hops, millet, oats, popcorn, rice, rye, sesame, sorghum, wheat, wild rice; citrus such as calamondin, citrus hybrids, grapefruit, kumquat, lemon, lime, mandarin, orange (sour and sweet), pomelo, tangerine; cotton; cote crops, such as broccoli, broccoli raab, brussels sprouts, cabbage (chinese), cauliflower, cavalo braccolo, collards, kale, kohlrabi, mizuna, mustard greens, mustard spinach, rape greens; cucurbit vegetables, such as: cantaloupe, chayote, chinese waxgourd, citron melon, cucumbers, gherkin, edible gourds, muskmelon hybrids and/or cultivars, pumpkin, summer squash (such as crookneck and zucchini), watermelons, winter squash (such as acorn and butternut); fruiting vegetables, such as: eggplant, groundcherry, pepino, peppers (such as bell, chili, pimento and sweet peppers), tomatillo, and tomatoes; grapes; leafy vegetables, such as: amaranth, arugula, asparagus, cardoon, celery, celtuce, chervil, chrysanthemum, corn, salad, cress (garden and upland), dandelion, dock, endive, fennel, lettuce (head and leaf), orach, parsley, purslane (garden and winter), radicchio, rhubarb, spinach, swiss chard; pineapples; pome fruit, such as: apple, crabapple, loquat, mayhaw, pear (including oriental), quince; potatoes, root and tuber vegetables such as: arracacha, arrowroot, artichoke, canna (edible), cassaya, chayote (root), garlic, ginger, onion, potato, sweet potato, tanier, turmeric, yam bean, yam; root vegetables, such as: beet (garden & sugar), burdock (edible), carrot, celeriac, chervil, chicory, ginseng, horseradish, parsnip, radish, rutabaga, salsify, skirret, turnip; strawberries; stone fruit, such as: apricot, cherry (sweet and tart), nectarine, peach, plum, plumcot, prune (fresh); succulent, dried beans and peas such as: beans (phaseolus and vigna spp.), jackbean, pea (pisum spp.), pigeon pea, soybean, sword bean, and dried cultivars of bean (lupinus, phaseolus, vigna spp.), broad bean, chickpea, guar, lablab bean, lentil, and pea; tree nuts and pistachio, such as: almond, beech nut, brazil nut, butternut, cashew, chestnut, chinquapin, filbert, hickory nut, macadamia nut, pecan, walnut (black and english), and pistachio; tropical tree fruits, such as: avocado, cherimoya, coffee, guava, lychee, mango, papaya.

In particular, the methods and compositions herein may be effective with plants in the Leguminosae (Fabaceae) family, such as soybean or pea, the Brassicaceae (Cruciferae) family, such as canola, a fruiting vegetable plant, such as tomato, or a crop plant in the Poaceae (Gramineae) family, such as a cereal grain plant such as wheat.

Without restriction to a theory, it is believed that plants having an auxin response pathway will benefit from the methods claimed herein. The auxin response pathway may act by upregulating or downregulating other biochemical pathways in the plant. For example, the gibberellin (GA) biosynthetic pathways that may be upregulated or enhanced by application of the auxin or auxin analogs of the present invention, may benefit from the methods claimed herein. In another example, the auxin may inhibit an ethylene response pathway.

The discovery that auxin stimulates gibberellin (GA) biosynthesis at a specific step in the GA biosynthesis pathway during pea fruit growth was an early example of one class of hormone regulating another class of hormone for coordination of plant development (van Huizen et al. 1995 and 1997). Subsequently, researchers have found that a number of plant developmental processes including stem elongation and fruit development are hormonally regulated, at least partially, through the mechanism of auxin stimulation of GA biosynthesis (Ozga et al. 2003 and 2009; O'Neill and Ross 2002; Serrani et al. 2008).

Pea fruit (Pisum sativum) has been a model system to understand how hormones are involved in fruit development (Eeuwens and Schwabe 1975; Sponsel 1982; Ozga et al. 1992; Reinecke et al. 1995; Rodrigo et al. 1997; Ozga et al. 2009). A fruit consists of an ovary (pericarp) and the enclosed seeds. The functions of the pericarp are to protect the developing seeds against mechanical damage, to stabilize the micro-environment during seed ontogeny, and to act as a physiological buffer against fluctuations in the nutrient supply (Müntz et al. 1978). Fruit development involves a complex interaction of molecular, biochemical, and structural changes to bring about cell division, enlargement and differentiation that transform a fertilized ovary into a mature fruit. Pea flowers are self-pollinating. When petals are fully reflexed, flowers are said to be at anthesis (full bloom) and morphological characteristics used to stage or track fruit development are measured in the number of days after anthesis (DAA). In most fruits, normal ovary (pericarp) growth requires the presence of seeds, and the final weight of the fruit is often proportional to the number of developing seeds (Nitsch 1970). This is the case in pea, where pericarp growth (length, fresh weight and dry weight) was positively correlated with initial seed number, and the removal or destruction of the seeds 2 to 3 DAA resulted in the slowing of pericarp growth and subsequently abscission (Eeuwens and Schwabe 1975; Ozga et al. 1992). Similarly, seed number is also positively correlated with ovary size in Arabidopsis and tomato (Cox and Swain 2006; c.f. Gillaspy et al. 1993). Chemical signals such as hormones originating from the seeds may be responsible for continued fruit development by maintaining the necessary hormone levels for pericarp growth (Eeuwens and Schwabe 1975; Sponsel 1982; Ozga et al. 1992).

In addition to GAs, developing pea seeds and pericarps contain two auxins, 4-chloroindole-3-acetic acid (4-Cl-IAA) and indole-3-acetic acid (IAA) (Magnus et al. 1997). A split-pericarp assay where test compounds are applied to the inner wall of split and deseeded pericarps that are still attached to the plant has been developed to examine the effects of exogenously applied growth substances on pericarp growth. During early pericarp growth (2 DAA), application of bioactive GAs or 4-Cl-IAA to deseeded pericarps can substitute for seeds in stimulating pericarp growth, but IAA cannot (Reinecke et al. 1995; Eeuwens and Schwabe 1975; Ozga and Reinecke 1999).

During early pea fruit growth, the physiological roles of 4-chloroindole-3-acetic acid (4-Cl-IAA) and IAA, both natural pea auxins, in regulating gibberellin (GA) 20-oxidase gene expression (PsGA20ox1) were tested with 4-position, ring-substituted auxins that have a range of biological activities (fruit growth). The effect of seeds, and natural and synthetic auxins (4-Cl-IAA, and IAA; 4-Me-IAA, 4-Et-IAA and 4-F-IAA, respectively), and auxin concentration (4-Cl-IAA) on PsGA20ox1 mRNA levels in pea pericarp were investigated over a 24 h treatment period. The ability of certain 4-substituted auxins to increase PsGA20ox1 mRNA levels in deseeded pericarp was correlated with their ability to stimulate pericarp growth. The greatest increase in pericarp PsGA20ox1 mRNA levels and growth was observed when deseeded pericarps were treated with the naturally occurring pea auxin, 4-Cl-IAA; however, IAA was not effective. Silver thiosulfate, an ethylene action antagonist, did not reverse IAA's lack of stimulation of PsGA20ox1 over the control treatment. 4-Me-IAA was the second most active auxin in stimulating PsGA20ox1 and was the second most biologically active auxin. Application of the 4-substituted IAA analogs, 4-Et-IAA and 4-F-IAA, to deseeded pericarps resulted in minimal or no increase in PsGA20ox1 transcript levels or pericarp growth. Pericarp PsGA20ox1 mRNA levels increased with increasing 4-Cl-IAA concentration and showed transitory increases at low 4-Cl-IAA treatments (30 to 300 pmol).

It appears that 4-O-IAA, but not IAA, can substitute for the seeds in maintaining pea fruit growth in planta. The importance of the substituent at the 4-position of the indole ring has been tested by comparing the molecular properties of 4-X-IAA (X═H, Me, Et, F, or Cl) and their effect on the elongation of pea pericarps in planta (Molecular properties of 4-substituted indole-3-acetic acids affecting pea pericarp elongation, Reinecke et al., Plant Growth Regulation, Vol 27, No. 1, 39-48). Structure-activity is discussed there in terms of structural data derived from X-ray analysis, computed conformations in solution, semiempirical shape and bulk parameters, and experimentally determined lipophilicities and NH-acidities. The size of the 4-substituent, and its lipophilicity, are associated with growth promoting activity of pea pericarp, while there was no obvious relationship with electromeric effects.

These results support a unique physiological role for auxins in the regulation of GA metabolism by effecting PsGA20ox1 expression during early pea fruit growth.

In addition, the application of 4-Cl-IAA, but not IAA, was found to stimulate pericarp GA biosynthesis gene expression, specifically PsGA20ox1 and PsGA3ox1 (van Huizen et al. 1997; Ozga et al. 2003 and 2009) and repress the gene expression of the GA catabolic gene PsGA2ox1 (Ozga et al. 2009). These data suggest that 4-Cl-IAA-induced pericarp growth is in part mediated by coordinated regulation of PsGA20ox1, PsGA3ox1, and PsGA2ox1 transcription in the GA biosynthesis and catabolism pathway.

Auxin regulation of GA biosynthesis appears to be similar in the fruit of pea, tomato (Solanum lycopersicum), and Arabidopsis. Data from GA gene expression and GA quantitation studies suggest that the synthetic auxin 2,4-D induced parthenocarpic tomato fruit growth in part by increasing SlGA20ox and SlGA3ox1, and decreasing SlGA2ox2 message levels (Serrani et al. 2008), similar to the effects of the endogenous auxin 4-Cl-IAA on GA biosynthesis and deactivation genes in pea pericarps (Ozga et al., 2009). Similarly, specific AtGA20ox and AtGA3ox genes were up-regulated in non-pollinated fruits of Arabidopsis by the synthetic auxin 2-4,-D (Dorcey et al. 2009). It is apparent that specific bioactive auxins can developmentally, temporally, and spatially regulate levels of another class of hormones (GAs) at the transcript level to coordinate fruit growth and development.

The applicants have found that plant growth may be enhanced by application of the composition comprising an auxin or auxin analog during an early reproductive stage of the plant. In one embodiment, the application step may be taken at anthesis, or days or weeks before anthesis, such as at least one day (24 hours), or at least two days (48 hours), or at least one week prior to anthesis. In one embodiment, the composition may be applied at or before the start of the flowering stage. In one embodiment, the application step may be applied to seeds, or close to the seeding and germination stage.

In one aspect, the invention comprises a plant growth regulating composition including an effective amount of the auxin or auxin analogs identified herein or an agriculturally acceptable salt thereof, in association with, and preferably homogeneously dispersed in, one or more compatible agriculturally-acceptable diluents or carriers and/or surface active agents [i.e. diluents or carriers and/or surface active agents of the type generally accepted in the art as being suitable for use in herbicidal compositions and which are compatible with compounds of the invention]. The auxins may be in their free acid form or conjugated. The term “homogeneously dispersed” is used to include compositions in which the auxins are dissolved in other components. The term “growth regulating composition” is used in a broad sense to include not only compositions which are ready for use but also concentrates which must be diluted before use (including tank mixtures).

The growth regulating auxins can be formulated in various ways, depending on the prevailing biological and/or chemico-physical parameters. Examples of possible formulations which are suitable are: wettable powders (WP), water-soluble powders (SP), water-soluble concentrates, emulsifiable concentrates (EC), emulsions (EW) such as oil-in-water and water-in-oil emulsions, sprayable solutions, suspension concentrates (SC), dispersions on an oil or water basis, solutions which are miscible with oil, capsule suspensions (CS), dusts (DP), seed-dressing products, granules for broadcasting and soil application, granules (GR) in the form of microgranules, spray granules, coated granules and adsorption granules, water-dispersible granules (WG), water-soluble granules (SG), ULV formulations, microcapsules and waxes.

These individual formulation types are known in principle and described, for example, in: Winnacker-Kuchler, “Chemische Technologie” [Chemical Technology], Volume 7, C. HauserVerlag, Munich, 4th Edition 1986; Wade van Valkenburg, “Pesticide Formulations”, Marcel Dekker, N.Y., 1973; K. Martens, “Spray Drying Handbook”, 3rd Ed. 1979, G. Goodwin Ltd. London.

The necessary formulation auxiliaries such as inert materials, surfactants, solvents and other additives are also known and described, for example, in: Watkins, “Handbook of Insecticide Dust Diluents and Carriers”, 2nd Ed., Darland Books, Caldwell N.J.; H. v. Olphen, “Introduction to Clay Colloid Chemistry”, 2nd Ed., J. Wiley & Sons, N.Y.; C. Marsden, “Solvents Guide”, 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflachenaktive Athylenoxidaddukte” [Surface-active ethylene oxide adducts], Wiss. Verlagsgesell., Stuttgart 1976; Winnacker-Kuchler, “Chemische Technologie” [Chemical Technology], Volume 7, C. Hauser Verlag, Munich, 4th Ed. 1986.

Wettable powders are preparations which are uniformly dispersible in water and which, besides any active ingredients, also comprise ionic and/or nonionic surfactants (wetters, dispersants), for example, polyoxyethylated alkylphenols, polyoxyethylated fatty alcohols, polyoxyethylated fatty amines, fatty alcohol polyglycol ether sulfates, alkanesulfonates or alkylbenzenesulfonates, sodium lignosulfonate, sodium 2,2′-dinaphthylmethane-6,6′-disulfonate, sodium dibutylnaphthalenesulfonate or else sodium oleoylmethyltaurinate, in addition to a diluent or inert substance. To prepare the wettable powders, the growth regulating auxins are, for example, ground finely in conventional apparatuses such as hammer mills, blower mills and air-jet mills and mixed with the formulation auxiliaries, either concomitantly or thereafter.

Emulsifiable concentrates are prepared, for example, by dissolving the growth regulating auxins in an organic solvent, for example butanol, cyclohexanone, dimethylformamide, xylene or else higher-boiling aromatics or hydrocarbons or mixtures of these, with addition of one or more ionic and/or nonionic surfactants (emulsifiers). Emulsifiers which can be used are, for example: calcium salts of alkylarylsulfonic acids, such as calcium dodecylbenzenesulfonate or nonionic emulsifiers, such as fatty acid polyglycol esters, alkylaryl polyglycol ethers, fatty alcohol polyglycol ethers, propylene oxide/ethylene oxide condensates, alkyl polyethers, sorbitan esters such as sorbitan fatty acid esters or polyoxyethylene sorbitan esters such as polyoxyethylene sorbitan fatty acid esters.

Dusts are obtained by grinding the active substance with finely divided solid substances, for example talc or natural clays, such as kaolin, bentonite or pyrophyllite, or diatomaceous earth.

Suspension concentrates may be water- or oil-based. They can be prepared, for example, by wet grinding by means of commercially available bead mills, if appropriate with addition of surfactants, as they have already been mentioned above for example in the case of the other formulation types.

Emulsions, for example oil-in-water emulsions (EW), can be prepared for example by means of stirrers, colloid mills and/or static mixtures using aqueous organic solvents and, if appropriate, surfactants as they have already been mentioned above for example in the case of the other formulation types.

Granules can be prepared either by spraying the growth regulating auxins onto adsorptive, granulated inert material or by applying active substance concentrates onto the surface of carriers such as sand, kaolinites or of granulated inert material, by means of binders, for example polyvinyl alcohol, sodium polyacrylate or alternatively mineral oils. Suitable active substances can also be granulated in the manner which is conventional for the production of fertilizer granules, if desired in a mixture with fertilizers.

Water-dispersible granules are prepared, as a rule, by the customary processes such as spray-drying, fluidized-bed granulation, disk granulation, mixing in high-speed mixers and extrusion without solid inert material. To prepare disk, fluidized-bed, extruder and spray granules, see, for example, processes in “Spray-Drying Handbook” 3rd ed. 1979, G. Goodwin Ltd., London; J. E. Browning, “Agglomeration”, Chemical and Engineering 1967, pages 147 et seq.; “Perry's Chemical Engineer's Handbook”, 5th Ed., McGraw-Hill, New York 1973, p. 8-57.

For further details on the formulation of crop protection products, see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

Based on these formulations, it is also possible to prepare combinations with safeners, fertilizers and/or other growth regulators, such as a cytokinin or a gibberellins, or another auxin or auxin analog.

In one embodiment, the compositions herein may comprise with pesticidally active substances such as, for example, insecticides, acaricides, herbicides, fungicides, for example in the form of a ready mix, pre-mix or a tank mix. These combinations may be applied to a crop at a suitable stage for pesticidal activity and for the enhanced growth effect of the auxin or auxin analog.

In one embodiment, the growth regulating auxin may be present in solution in a concentration of between about 10⁻⁴ to about 10⁻⁷ M. In one embodiment, the volume of composition applied to a plant or a crop may be chosen to apply a desired weight of the auxin or auxin analog to the crop, which may be about 0.0001 g to about 20 g/hectare. In one embodiment, the auxin or auxin analog may be applied between about 8.39 mg to about 9.38 g per hectare (3.4 mg to about 3.8 g per acre) of crop.

In one example, the table below grams of 4-chloro IAA volume per hectare (gai/Ha) at various application rates (gallons per acre (GPA), litres per acre (L/A), or litres per hectare (L/Ha), at both 10⁻⁴ and 10⁻⁷ M concentrations. Equivalent calculations may be made for 4-Me-IAA or other IAA derivatives using their known molecular weights.

gai/Ha

| GPA | L/A | L/Ha | 1 × 10⁻⁴M | 1 × 10⁻⁷M |
|---|---|---|---|---|
| 2 | 7.57 | 18.71 | 0.39 | 0.00039 |
| 10 | 37.85 | 93.54 | 1.96 | 0.00196 |
| 20 | 75.70 | 187.08 | 3.92 | 0.00392 |
| 100 | 378.54 | 935.39 | 19.60 | 0.01961 |

In addition, the formulations of the growth regulating auxins mentioned comprise, if appropriate, the adhesives, wetters, dispersants, emulsifiers, penetrants, preservatives, antifreeze agents, solvents, fillers, carriers, colorants, antifoams, evaporation inhibitors, pH regulators and viscosity regulators which are conventional in each case.

Suitable formulations for plant growth regulating compositions are well-known to those skilled in the art. Formulations or compositions for plant growth regulating uses can be made in a similar way, adapting the ingredients, if necessary, to make them more suitable to the plant or soil to which the application is to be made.

By virtue of the practice of the present invention, a wide variety of plant growth responses, which may include the following (non-ranked listing), may be induced: increased pollen viability, increased fruit retention, increased seed number, increased seed yield, increased stem length, increased petiole length and thickness, increased peduncle length and thickness, and stimulation of plant maturation (dry-down) under abiotic stress and non-stress conditions. It is intended that as used in the instant specification the term “method for plant growth regulation” or “enhanced plant growth” means the achievement of any or all of the aforementioned eight categories of response or any other modification of plant, seed, fruit or vegetable (whether the fruit or vegetable is not harvested or harvested) so long as the net result is to increase growth or benefit any property of the plant, seed, fruit or vegetable as distinguished from any pesticidal action (unless the present invention is practiced in conjunction with or in the presence of a pesticide, for example a herbicide). The term “fruit” as used herein is to be understood as meaning anything of economic value that is produced by the plant.

Preferably, at least an increase of 10% of one or more of the respective plant growth response is obtained.

Although the preferred method of application of the compounds used in the process of this invention is directly to the foliage and stems of plants, the compounds can also be applied to the locus of the plant.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

### EXAMPLES

The following examples are provided to illustrate exemplary embodiments of the invention, and not to limit the claimed invention unless explicitly referred to in a limiting manner.

### Example 1

### Pea Plants

‘Carneval’ (Pisum sativum L.) was chosen as a model cultivar as a semi-dwarf (semi-leafless; an field pea which is used extensively in crop agriculture. ‘Carneval’ has white flowers and yellow cotyledons at maturity, begins to flower at about the 15 to 17^{th} node under long day conditions. Seeds of ‘Carneval’ were planted at an approximate depth of 2.5 cm in 3-L plastic pots (4 seeds per pot and thinned to 2 plants per pot after approximately 2 weeks) in 1:1 Sunshine #4 potting mix (Sun Gro Horticulture, Vancouver, Canada) and sand. Approximately 15 cc of slow-release fertilizer (14-14-14) was added to the potting mix at planting. The experiment was arranged in a completely randomized design and grown at the University of Alberta in a growth chamber set at 19° C./17° C. (day/night) with a 16/8-h photoperiod under cool-white fluorescent lights (F54/15/835/HO high fluorescent bulbs, Phillips, Holland; 350 μE m² s⁻², measured with a LI-188 photometer, Li-Cor Biosciences, Lincoln, Nebr.). For the heat stress treatment, plants were placed in a separate growth chamber with a 16/8-h photoperiod under cool-white fluorescent lights (F54/15/835/HO high fluorescent bulbs, Phillips, Holland) for 4 days where the temperature was cycled over a 24 hr period as follows: 34° C. air temperature for 6 hours per day (between 11:00 and 17:00 hrs) for 4 days during the light cycle; the remainder of the light cycle was maintained at a 22° C. air temperature; the dark cycle was maintained at 19° C. After the 4 day heat treatment, the plants were returned to the same growth chamber they were originally grown in, where they were taken to maturity. One application of 4-ME-IAA (1 μM in 0.1% Tween 80) or 0.1% Tween 80 (control) was applied as a spray to the entire plant to cover when the first flowering node of the main stem was at the flower bud or full bloom stage. For the heat stress treatment, the hormone or control application was completed 16 hrs prior to the initiation of the first heat-stress cycle.

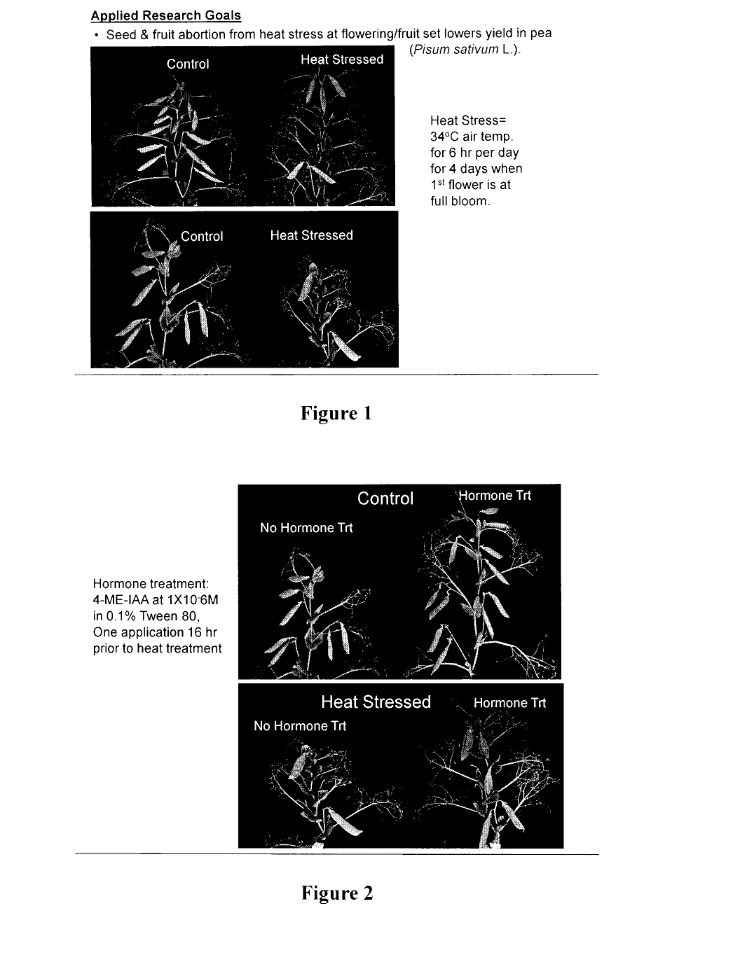

Specific Results: Heat stress at the time of reproductive development can result in flower, fruit and seed abortion that dramatically reduces the number of developing fruit of pea plants (FIG. 1). Application of 4-ME-IAA to the plant when the first flowering node was at the floral bud or full bloom (anthesis) stage increased pod retention in pea plants grown under non-stressed conditions by 41%, and under heat-stress conditions by 112% when measured 9-10 days after application (Table 1; FIG. 2). At plant maturity, the 4-ME-IAA-treated plants also exhibited 42% more pods per plant with mature seeds than the control plants under non-stressed conditions (Table 2). At plant maturity, 4-ME-IAA application also increased the number of seeds per plant (39%) and the total seed weight per plant (23%) compared to the control plants (Table 2). The weight per seed was greater in the control plants (270 mg per seed) compared to those from the 4-ME-IAA-treated plants (240 mg per seed). An inverse relationship between seed number and seed size per plant is normally observed in most plant species due to resource partitioning by the plant. On a whole plant basis, since the ratio of the number of stems per plant to the number of stem with pods was similar among the 4-Me-IAA-treated and control plants (Table 2), the 4-ME-IAA stimulated increase in yield was not due to an increase in the number of stems with pods, but instead to an increase in the number of pods per existing stems.

TABLE 1
Number of pods (greater than 20 cm) with developing seeds
9 to 10 days after removal from heat treatment of
Pisum sativum L. cv. Carneval plants.^{a}

Number of pods with developing
seeds per plant

| | Heat-stressed^{b} | Non-stressed^{c} |
|---|---|---|
| Control | 5 ± 0.8^{d} | 10.9 ± 1.3 |
| 4-ME-IAA^{e} | 10.6 ± 0.8 | 15.4 ± 0.6 |

^{b}Heat treatment was 34° C. air temperature for 6 hours per day for 4 days during the light cycle, the remainder of the light cycle was maintained at a 22° C. air temperature; the dark cycle was maintained at 19° C.; photoperiod = 16 h light/8 h dark.
^{c}Non-stress temperature conditions were 19° C./17° C. light/dark, 16 h light/8 h dark.
^{d}Data are means ± standard error (SE), n = 8 plants.
^{e}Hormone treatment: 4-ME-IAA at 1 μM in 0.1% Tween 80, one application 16 hr prior to initiation of heat treatment.

TABLE 2
Number of pods with seeds and seeds per plant, total seed weight per plant, weight per
seed, and the ratio of number of stems per plant to stems with pods at plant maturity
in Pisum sativum L. cv. Carneval plants grown in non-heat stressed conditions (control)
treated with 4-ME-IAA in 0.1% Tween 80 or a control solution (0.1% Tween 80).^{a}

| | | Number of | Total seed | | Number of stems/ |
|---|---|---|---|---|---|
| | Number of | seeds per | weight per | Weight per | stems with pods |
| | pods per plant | plant | plant (g) | seed (g) | per plant |
| Control | 10.5 ± 1.2^{b} | 41.4 ± 5.1 | 11.05 ± 1.22 | 0.27 ± 0.01 | 1.2 ± 0.1 |
| 4-ME-IAA^{c} | 14.9 ± 0.6 | 57.6 ± 3.5 | 13.56 ± 0.64 | 0.24 ± 0.01 | 1.1 ± 0.1 |

^{a}Non-stress temperature conditions were 19° C./17° C. light/dark, 16 h light/8 h dark;
^{b}Data are means ± standard error (SE), n = 8 plants.
^{c}Hormone treatment: one application of 4-ME-IAA at 1 μM in 0.1% Tween 80, sprayed on entire plant to cover.

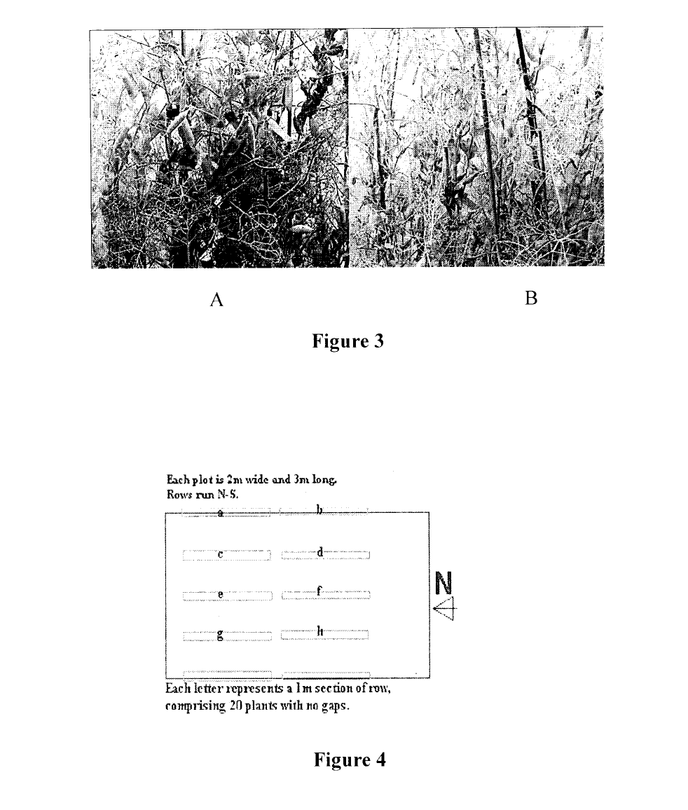

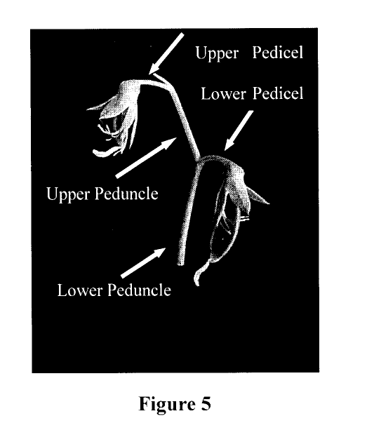

FIG. 3 shows representative plants showing the effect of 4-ME-IAA on plant maturation. (A) Pea plants sprayed with one application of 0.1% Tween 80 (control treatment). (B) Plants sprayed with one application of 4-ME-IAA (1 μM) in 0.1% Tween 80. Plants were sprayed when the first flowering node was at floral bud or full bloom, and the pictures were taken 34 days after hormone or control spray application. 4-ME-IAA stimulated maturation of the plant (faster dry-down of the plant from the green vegetative state to the yellow dry state).

In a field study, pea (Pisum sativum L. cv. Carneval) seed with a germination rate assessed at greater than 95% was planted on May 11, 2011 into black-loam soil that had been clean-cultivated for two previous growing seasons located at the Edmonton Research Station (ER31) of the University of Alberta, Edmonton, Alberta, Canada. The treatment plots measured 2 m wide by 3 m long, comprising rows 50 cm apart. The seeds were precision-drilled by hand at 5 cm intervals in each row. At the time of seeding, fresh TagTeam® granular rhizobial inoculant was drilled with the seed at the rate of 1.11 g per 6 m². No herbicides or pesticides were used during this study and plots were manually weeded to maintain weed-free plots. Seed emergence began on May 26, 2011 (15 days post-planting) due to cool temperature conditions after planting. Precipitation during the growing season was within the regional average. The treatments consisted of one application of aqueous 4-methyl-indole-3-acetic acid (4-ME-IAA) solutions at 1×10⁻⁶M, 1×10⁻⁵M, 5×10⁻⁵M, or 1×10⁻⁴M in 0.1% (v/v) Tween 80, or an aqueous control solution (0.1% [v/v] Tween 80) applied to the plants on Jul. 10, 2011, when about 5% of the plants were in first flower (1 treatment per plot; 5 treatments/plots total). A separate Chapin 20000-type 4 L pneumatic sprayer was used for applying each treatment solution; each sprayer was equipped with a medium-delivery blue fan nozzle designed to deliver 1.4 L per minute at the normal operating pressure of 40 PSI. Each plot was sprayed with a total of 0.7 L of solution to obtain uniform coverage. At the time of spraying, the mean day temperature was 15.9° C., the mean wind speed was 7 km/h, the relative humidity was 86%, and the sky was overcast. Harvesting (by hand) took place Aug. 27 to 30, 2011 after the plants had desiccated naturally. The pods were further dried for six days in a forced-air drier at 30° C. prior to obtaining seed weights. Each plot was harvested in eight groups of 20 contiguous plants arranged so that each group (1 m section of row) had at least two plants immediately next to it at each end. The treatment replication unit was 20 contiguous plants as diagramed in Figure P1. As the between-row spacing was 50 cm, the yield from each group represented that from 0.5 m²

For growth chamber experiment, seeds of ‘Carneval’ were planted at an approximate depth of 2.5 cm in 3-L plastic pots (4 seeds per pot and thinned to 2 plants per pot after approximately 2 weeks) in 1:1 Sunshine #4 potting mix (Sun Gro Horticulture, Vancouver, Canada) and sand. The experiment was arranged in a completely randomized design and grown at the University of Alberta in a growth chamber set at 19° C./17° C. (day/night) with a 16/8-h photoperiod under cool-white fluorescent lights (54W/835/HO high fluorescent bulbs, Phillips, Holland; 350 μE m² s⁻²). For the heat stress treatment, plants were placed in a separate growth chamber with a 16/8-h photoperiod under cool-white fluorescent lights (F54/15/835/HO high fluorescent bulbs, Phillips, Holland) for 4 days where the temperature was cycled over a 24 hr period as follows: 33° C. air temperature for 6 hours per day (between 11:00 and 17:00 hrs) for 4 days during the light cycle; the remainder of the light cycle was maintained at a 22° C. air temperature; the dark cycle was maintained at 19° C. After the 4 day heat treatment, the plants were returned to the same growth chamber they were originally grown in, where they were taken to maturity.

For experiment 1, aqueous 4-chloro-indole-3-acetic acid (4-Cl-IAA) solutions at 1×10⁻⁷, 1×10⁻⁶, or 1×10⁻⁵M in 0.1% (v/v) Tween 80 or aqueous 0.1% (v/v) Tween 80 (control) were applied one time as a spray to the entire plant to cover when the first flowering node of the main stem was near or at anthesis.

For experiment 2, aqueous 4-methyl-indole-3-acetic acid (4-ME-IAA) solutions at 1×10⁻⁷, 1×10⁻⁶, 1×10⁻⁵, or 1×10⁻⁴ M in 0.1% (v/v) Tween 80 or aqueous 0.1% (v/v) Tween 80 (control) were applied as a spray to the entire plant to cover when the first flowering node of the main stem was near or at anthesis. In addition to the application at the timing cited above, one application of 4-ME-IAA at 1×10⁻⁶ M or 1×10⁻⁵ M was made when the floral buds were tightly clustered inside the stipule leaves at the stem apex (floral buds not visible outside of stipule leaves; designated the ‘Early’ treatment). In the heat stress treatment, the hormone or control treatment application was completed 16 hrs prior to the initiation of the first heat-stress cycle. The length and diameter (measured mid-length) of the lower and upper peduncles and pedicels of the inflorescence with two pods (or the lower peduncle and pedicel if a single pod node) at the first, second, third and fourth flowering nodes of the main stem of pea plants were determined for hormone-treated and control plants. Standard error of the mean (SE) was calculated for the means of all data for a measure of statistical significance in comparing treatment means.

Results:

Field Study

One application of 4-ME-IAA at 1×10⁻⁶ M or 1×10⁻⁴ M when approximately 5% of the plants were at first flower increased the seed yield of ‘Carneval’ field pea by 43% and 28%, respectively (Table P1). These data demonstrate positive agronomic effects of 4-ME-IAA for increasing pea seed yield in the field.

Growth Chamber Studies

### Experiment 1

A single application of 4-Cl-IAA at 1×10⁻⁶ M or 1×10⁻⁵ M applied when the first flowering node of the main stem was near or at anthesis increased seed yield by 65% and 62%, respectively (Table P2).

### Experiment 2

The length and diameter of the lower and upper peduncles and pedicels of the inflorescence with two pods (or the lower peduncle and pedicel if a single pod node) at the first, second, third and fourth flowering nodes of the main stem of pea plants were assessed to determine if 4-ME-IAA treatments affect the development of these tissues (Figure P2). For the first flowering node, 4-ME-IAA application at 1×10⁻⁷, 1×10⁻⁶, 1×10⁻⁵, or 1×10⁻⁴ M increased the length and diameter of the lower peduncle compared to the control (Table P3). 4-ME-IAA application at 1×10⁻⁷, 1×10⁻⁶, and 1×10⁻⁵ increased the upper peduncle length, but not the diameter when compared to the control. Interestingly, 4-ME-IAA increased the upper peduncle diameter only at 1×10⁻⁴ M. 4-ME-IAA application at the higher concentrations (1×10⁻⁵ or 1×10⁻⁴ M) decreased both the lower and upper pedicel length. 4-ME-IAA application increased the lower pedicel diameter at 1×10⁻⁶ and 1×10⁻⁴ M, and increased the upper pedicel diameter at all concentrations tested (Table P3). In general, 4-ME-IAA application induced similar growth changes in the peduncle and pedicel tissues at the second flowering node as observed for the first flowing node, with two exceptions (Table P4). 4-ME-IAA treatment did not affect the upper peduncle length, and 4-ME-IAA increased the upper peduncle diameter at three of the four concentrations applied (Table P4). At the third flowering node, only 20% of the plants (2 out of 10) produced inflorescences with two pods in the control treatment (Table P5). Treatment with 4-ME-IAA (1×10⁻⁷ to 1×10⁻⁴ M) increased the number of inflorescences with 2 pods at the third flowering node to 80-100% of the plants (8 to 10 out of 10; Table P5). Similarly, at the fourth flowering node, 4-ME-IAA treatment increased the number of inflorescences with two pods from 10% of the plants (1 out of 10) to 70-90% of the plants (7 to 9 out of 10; Table P6). In general, 4-ME-IAA application induced similar growth changes in the lower peduncle and pedicel tissues at the third and fourth flowering node as that observed in these tissues in the first and second flowering nodes. Due to the minimal number of inflorescences with 2 pods at the third and fourth flowering nodes of the control plants (lower pod is present but no upper pod), we did not compare the 4-ME-IAA-treated upper peduncle and pedicel tissue with the corresponding control tissue.

Overall, these data suggest that 4-ME-IAA promotes peduncle and pedicel growth and development which may include increased vascularization in these tissues that connect the pod and developing seeds to the maternal plant and the major source of photosynthetic assimilates required for seed growth and development. The increase in the number of two pod inflorescences with 4-ME-IAA treatment suggests that the promotive effect of 4-ME-IAA on peduncle/pedicel growth and development leads to the retention of the upper flower/developing fruit of the inflorescence and at least in part this leads to increased seed yield.

Aqueous 4-ME-IAA solutions at 1×10⁻⁷, 1×10⁻⁶, 1×10⁻⁵ or 1×10⁻⁴M applied one time as a spray to the entire pea plant to cover when the first flowering node of the main stem was near or at anthesis increased seed yield (seed weight per plant) by 78%, 71%, 61% and 61%, respectively, compared to the control (0.1% Tween 80; Table P 11). Furthermore, one application of 4-ME-IAA at 1×10⁻⁶ M or 1×10⁻⁵ M when the floral buds were tightly clustered inside the stipule leaves at the stem apex (‘Early’ treatment Table P11) increased the number of seeds produced from lateral stems (ratio of seed number on the main stem to seed number on the lateral stems was 1.5 to 1.6 in the ‘Early’ 4-ME-IAA treatments; Table P 11), when compared to the application timing approximately 1.5 to 2 weeks later when the first flowering node was near or at anthesis (control ratio 3:1; Table P11). Application of 4-ME-IAA (at 1×10⁻⁶ M) at the tight floral bud stage (‘Early’ treatment) also increased seed yield to a greater extent than when applied at the time the first flowering node was near or at anthesis (Table P11). The ‘Early’ 4-ME-IAA (at 1×10⁻⁶ M) increased seed yield by 109% when compared to the control treatment (Table P11). Interestingly, in general seed size did not decrease with the increase in seed number per plant observed in all the 4-ME-IAA treatments, but remained relatively consistent regardless of treatment (Table P11).

When pea plants were exposed to mild temperature heat stress conditions, the most consistent 4-ME-IAA effect on the growth and development of the peduncle and pedicel tissue was at 1×10⁻⁷M (Tables P7, P8, P9, and P10). At this concentration, 4-ME-IAA increased the length and diameter of the lower peduncle at the first, second, third and fourth flowering nodes, and the upper peduncle diameter at the first, second and fourth flowering nodes compared to the control. 4-ME-IAA application at 1×10⁻⁷M also increased the upper pedicel length at the first, second and third flowering nodes and the lower pedicel diameter at the first and third flowering nodes when compared to the control (Tables P7, P8, and P9).

Consistent with the promotive effects of 4-ME-IAA at 1×10⁻⁷M on peduncle and pedicel growth and development, 4-ME-IAA at this concentration increased the seed yield (seed number per plant by 30% and seed weight per plant by 29%) over the control when it was applied to plants prior to exposure to mild heat stress conditions (Table P12). Seed size did not decrease with the increase in seed number per plant observed in the heat stress 4-ME-IAA 1×10⁻⁷M treatment when compared to the control (Table P 12). These data suggest that 4-ME-IAA can partially reverse the negative effects of heat stress on seed yield when it is applied to the plant prior to the stress event.

TABLE P1
Seed yield of field grown pea ‘Carneval’ treated
with 4-ME-IAA or control solutions.

| | Seed yield per |
|---|---|
| Treatment^{a} | 1 meter row (g) |
| Control | 96.37 ± 6.82^{b} |
| (0.1% Tween 80) | |
| 4-ME-IAA 1 × 10⁻⁶M | 137.84 ± 10.16 |
| (in 0.1% Tween 80) | |
| 4-ME-IAA 1 × 10⁻⁵M | 105.63 ± 10.72 |
| (in 0.1% Tween 80) | |
| 4-ME-IAA 5 × 10⁻⁵M | 78.85 ± 12.06 |
| (in 0.1% Tween 80) | |
| 4-ME-IAA 1 × 10⁻⁴M | 123.20 ± 9.19 |
| (in 0.1% Tween 80) | |

^{a}Hormone treatments: aqueous solutions of 4-ME-IAA (1 × 10⁻⁶ to 1 × 10⁻⁴M) in 0.1% Tween 80; Control solution aqueous 0.1% Tween 80; one application sprayed on plant to cover when about 5% of the plants were in first flower.
^{b}Data are means ± SE, n = 8 (1 m rows).

TABLE P2
Seed yield of growth chamber grown pea ‘Carneval’ treated
with 4-CI-IAA or control solutions.
Experiment 1

| Treatment^{a} | Seed yield per plant (g) |
|---|---|
| Control | 11.30 ± 1.28^{b} |
| (0.1% Tween 80) | |
| 4-Cl-IAA | 13.60 ± 1.33 |
| 1 × 10⁻⁷M | |
| (in 0.1% Tween 80 | |
| 4-Cl-IAA | 18.61 ± 1.65 |
| 1 × 10⁻⁶M | |
| (in 0.1% Tween 80) | |
| 4-Cl-IAA | 18.28 ± 1.55 |
| 1 × 10⁻⁵M | |
| (in 0.1% Tween 80) | |

^{a}One treatment application applied to the entire plant to cover when the first flowering node was near or at anthesis.
^{b}Data are means ± SE, n = 10 plants.

TABLE P3
The length and diameter of the lower and upper peduncles and pedicels of the inflorescence with two pods at the first
flowering node of pea plants cv. ‘Carneval’ treated with 4-ME-IAA or control solutions.

| Experiment 2 | Lower | Upper | Lower | Upper | Lower | Upper | Lower | Upper |
|---|---|---|---|---|---|---|---|---|
| 1^{st} Flowering | Peduncle | Peduncle | Peduncle | Peduncle | Pedicel | Pedicel | Pedicel | Pedicel |
| node | Length | Length | diameter | diameter | Length | Length | diameter | diameter |
| Treatment^{a} | (mm) | (mm) | (mm) | (mm) | (mm) | (mm) | (mm) | (mm) |
| Control | 52.20 ± 5.11^{b} | 15.2 ± 1.74 | 1.41 ± 0.07 | 1.32 ± 0.07 | 9.60 ± 0.31 | 9.6 ± 0.22 | 1.58 ± 0.04 | 1.38 ± 0.04 |
| (0.1% Tween 80) | | | | | | | | |
| 4-ME-IAA | 67.10 ± 5.30 | 19.80 ± 1.08 | 1.59 ± 0.04 | 1.27 ± 0.05 | 9.30 ± 0.26 | 9.20 ± 0.20 | 1.65 ± 0.04 | 1.52 ± 0.03 |
| 1 × 10⁻⁷M | | | | | | | | |
| (in 0.1% Tween 80) | | | | | | | | |
| 4-ME-IAA | 75.00 ± 4.00 | 20.30 ± 1.54 | 1.65 ± 0.03 | 1.37 ± 0.05 | 9.40 ± 0.27 | 9.40 ± 0.27 | 1.70 ± 0.04 | 1.54 ± 0.04 |
| 1 × 10⁻⁶M | | | | | | | | |
| (in 0.1% Tween 80) | | | | | | | | |
| 4-ME-IAA | 63.10 ± 4.95 | 19.90 ± 1.12 | 1.53 ± 0.05 | 1.31 ± 0.03 | 8.70 ± 0.45 | 8.70 ± 0.37 | 1.58 ± 0.04 | 1.49 ± 0.03 |
| 1 × 10⁻⁵M | | | | | | | | |
| (in 0.1% Tween 80) | | | | | | | | |
| 4-ME-IAA | 69.70 ± 4.21 | 15.20 ± 1.36 | 1.73 ± 0.07 | 1.44 ± 0.03 | 8.50 ± 0.37 | 8.10 ± 0.43 | 1.73 ± 0.05 | 1.54 ± 0.05 |
| 1 × 10⁻⁴M | | | | | | | | |
| (in 0.1% Tween 80) | | | | | | | | |

^{a}One treatment application applied to the entire plant to cover when the first flowering node was near or at anthesis.
^{b}Data are means ± SE, n = 10. All 10 plants per treatment produced two pods at the first flowering node.

TABLE P4
The length and diameter of the lower and upper peduncles and pedicels of the inflorescence with two pods at the
second flowering node of pea plants cv. ‘Carneval’ treated with 4-ME-IAA or control solutions.

| | Lower | Upper | Lower | Upper | Lower | Upper | Lower | Upper |
|---|---|---|---|---|---|---|---|---|
| Experiment 2 | Peduncle | Peduncle | Peduncle | Peduncle | Pedicel | Pedicel | Pedicel | Pedicel |
| 2^{nd} Flowering node | Length | Length | diameter | diameter | Length | Length | diameter | diameter |
| Treatment^{a} | (mm) | (mm) | (mm) | (mm) | (mm) | (mm) | (mm) | (mm) |
| Control | 40.10 ± 4.93^{b} | 17.89 ± 0.92 | 1.39 ± 0.04 | 1.11 ± 0.06 | 9.8 ± 0.29 | 9.11 ± 0.26 | 1.46 ± 0.03 | 1.34 ± 0.06 |
| (0.1% Tween 80) | | | | | | | | |
| 4-ME-IAA | 55.80 ± 4.61 | 19.00 ± 0.76 | 1.57 ± 0.03 | 1.25 ± 0.02 | 9.3 ± 0.30 | 9.20 ± 0.29 | 1.57 ± 0.05 | 1.48 ± 0.04 |
| 1 × 10⁻⁷M | | | | | | | | |
| (in 0.1% Tween 80) | | | | | | | | |
| 0.04-ME-IAA | 58.20 ± 5.41 | 19.00 ± 0.60 | 1.51 ± 0.04 | 1.26 ± 0.02 | 9.4 ± 0.27 | 9.20 ± 0.33 | 1.51 ± 0.04 | 1.47 ± 0.04 |
| 1 × 10⁻⁶M | | | | | | | | |
| (in 0.1% Tween 80) | | | | | | | | |
| 4-ME-IAA | 53.50 ± 5.01 | 18.10 ± 0.74 | 1.45 ± 0.04 | 1.16 ± 0.03 | 8.80 ± 0.33 | 8.60 ± 0.37 | 1.50 ± 0.04 | 1.39 ± 0.04 |
| 1 × 10⁻⁵M | | | | | | | | |
| (in 0.1% Tween 80) | | | | | | | | |
| 4-ME-IAA | 55.60 ± 4.08 | 18.40 ± 0.72 | 1.67 ± 0.06 | 1.38 ± 0.05 | 8.30 ± 0.47 | 8.3 ± 0.47 | 1.65 ± 0.05 | 1.55 ± 0.05 |
| 1 × 10⁻⁴M | | | | | | | | |
| (in 0.1% Tween 80) | | | | | | | | |

^{a}One treatment application applied to the entire plant to cover when the first flowering node was near or at anthesis.
^{b}Data are means ± SE, n = 10 except for the control treatment upper peduncle and upper pedicel data, where n = 9. All 10 plants per treatment produced two pods at the second flowering node with one exception, the control treatment had 9 plants produce two pods at this node and one plant that produced one pod at this node.

TABLE P5
The length and diameter of the lower and upper peduncles and pedicels of the inflorescence with two pods at the third
flowering node of pea plants cv. ‘Carneval’ treated with 4-ME-IAA or control solutions.

| | Lower | Upper | Lower | Upper | Lower | Upper | Lower | Upper |
|---|---|---|---|---|---|---|---|---|
| Experiment 2 | Peduncle | Peduncle | Peduncle | Peduncle | Pedicel | Pedicel | Pedicel | Pedicel |
| 3^{rd} Flowering node | Length | Length | diameter | diameter | Length | Length | diameter | diameter |
| Treatment^{a} | (mm) | (mm) | (mm) | (mm) | (mm) | (mm) | (mm) | (mm) |
| Control | 33.50 ± 5.2^{b} | 17.50 ± 2.50 | 1.25 ± 0.04 | 1.09 ± 0.04 | 9.17 ± 0.31 | 10.00 ± 0.00 | 1.24 ± 0.05 | 1.37 ± 0.06 |
| (0.1% Tween 80) | (6)^{c} | (2) | (6) | (2) | (6) | (2) | (6) | (2) |
| 4-ME-IAA | 48.44 ± 2.5 | 18.38 ± 1.10 | 1.42 ± 0.05 | 1.07 ± 0.03 | 9.44 ± 0.18 | 9.00 ± 0.33 | 1.46 ± 0.04 | 1.26 ± 0.05 |
| 1 × 10⁻⁷M | (9) | (8) | (9) | (8) | (9) | (8) | (9) | (8) |
| (in 0.1% Tween 80) | | | | | | | | |
| 4-ME-IAA | 45.90 ± 4.3 | 18.00 ± 0.96 | 1.49 ± 0.04 | 1.17 ± 0.02 | 9.00 ± 0.30 | 9.00 ± 0.29 | 1.39 ± 0.04 | 1.31 ± 0.04 |
| 1 × 10⁻⁶M | (10) | (9) | (10) | (9) | (10) | (9) | (10) | (9) |
| (in 0.1% Tween 80) | | | | | | | | |
| 4-ME-IAA | 47.11 ± 4.73 | 20.44 ± 1.00 | 1.53 ± 0.03 | 1.13 ± 0.05 | 8.56 ± 0.41 | 8.67 ± 0.29 | 1.35 ± 0.04 | 1.25 ± 0.05 |
| 1 × 10⁻⁵M | (9) | (9) | (9) | (9) | (9) | (9) | (9) | (9) |
| (in 0.1% Tween 80) | | | | | | | | |
| 4-ME-IAA | 49.90 ± 4.2 | 19.10 ± 0.75 | 1.53 ± 0.05 | 1.21 ± 0.04 | 8.20 ± 0.33 | 8.10 ± 0.28 | 1.49 ± 0.06 | 1.40 ± 0.06 |
| 1 × 10⁻⁴M | (10) | (10) | (10) | (10) | (10) | (10) | (10) | (10) |
| (in 0.1% Tween 80) | | | | | | | | |

^{a}One treatment application applied to the entire plant to cover when the first flowering node was near or at anthesis.
^{b}Data are means ± SE.
^{c}number of samples used to calculate the mean and SE. The sample number represents the number of pods set at either the upper or lower floral positions on the inflorescence of the third flowering node from a total of 10 plants.

TABLE P6
The length and diameter of the lower and upper peduncles and pedicels of the inflorescence with two pods at the
fourth flowering node of pea plants cv. ‘Carneval’ treated with 4-ME-IAA or control solutions.

| | Lower | Upper | Lower | Upper | Lower | Upper | Lower | Upper |
|---|---|---|---|---|---|---|---|---|
| Experiment 2 | Peduncle | Peduncle | Peduncle | Peduncle | Pedicel | Pedicel | Pedicel | Pedicel |
| 4th Flowering node | Length | Length | diameter | diameter | Length | Length | diameter | diameter |
| Treatment^{a} | (mm) | (mm) | (mm) | (mm) | (mm) | (mm) | (mm) | (mm) |
| Control | 34.33 ± 2.19^{b} | 20 | 1.18 ± 0.06 | 1.1 | 9.33 ± 0.33 | 10 | 1.15 ± 0.05 | 1.19 |
| (0.1% Tween 80) | (3)^{c} | (1) | (3) | (1) | (3) | (1) | (3) | (1) |
| 4-ME-IAA | 44.00 ± 3.22 | 18.57 ± 0.61 | 1.37 ± 0.03 | 1.12 ± 0.03 | 9.57 ± 0.37 | 8.86 ± 0.55 | 1.37 ± 0.03 | 1.25 ± 0.04 |
| 1 × 10⁻⁷M | (7) | (7) | (7) | (7) | (7) | (7) | (7) | (7) |
| (in 0.1% Tween 80) | | | | | | | | |
| 4-ME-IAA | 38.00 ± 3.63 | 16.67 ± 0.69 | 1.38 ± 0.05 | 1.16 ± 0.03 | 8.80 ± 0.25 | 8.33 ± 0.29 | 1.34 ± 0.03 | 1.24 ± 0.05 |
| 1 × 10⁻⁶M | (10) | (9) | (10) | (9) | (10) | (9) | (10) | (9) |
| (in 0.1% Tween 80) | | | | | | | | |
| 4-ME-IAA | 40.22 ± 3.64 | 18.13 ± 0.88 | 1.41 ± 0.05 | 1.03 ± 0.08 | 9.00 ± 0.44 | 8.88 ± 0.44 | 1.22 ± 0.09 | 1.11 ± 0.10 |
| 1 × 10⁻⁵M | (9) | (8) | (9) | (8) | (9) | (8) | (9) | (8) |
| (in 0.1% Tween 80) | | | | | | | | |
| 4-ME-IAA | 41.00 ± 3.24 | 16.67 ± 0.39 | 1.36 ± 0.06 | 1.17 ± 0.04 | 8.44 ± 0.23 | 8.22 ± 0.14 | 1.42 ± 0.05 | 1.36 ± 0.06 |
| 1 × 10⁻⁴M | (9) | (9) | (9) | (9) | (9) | (9) | (9) | (9) |
| (in 0.1% Tween 80) | | | | | | | | |

^{a}One treatment application applied to the entire plant to cover when the first flowering node was near or at anthesis.
^{b}Data are means ± SE.
^{c}number of samples used to calculate the mean and SE. The sample number represents the number of pods set at either the upper or lower floral positions on the inflorescence of the fourth flowering node from a total of 10 plants.

TABLE P7
The length and diameter of the lower and upper peduncles and pedicels of the inflorescence with two pods at the first
flowering node of pea plants cv. ‘Carneval’ treated with 4-ME-IAA or control solutions when exposed to heat stress conditions.

| | Lower | Upper | Lower | Upper | Lower | Upper | Lower | Upper |
|---|---|---|---|---|---|---|---|---|
| Experiment 2 | Peduncle | Peduncle | Peduncle | Peduncle | Pedicel | Pedicel | Pedicel | Pedicel |
| 1st Flowering node | Length | Length | diameter | diameter | Length | Length | diameter | diameter |
| Treatment^{a} | (mm) | (mm) | (mm) | (mm) | (mm) | (mm) | (mm) | (mm) |
| HS^{b}-Contro1 | 53.60 ± 4.71^{c} | 16.63 ± 1.00 | 1.53 ± 0.07 | 1.27 ± 0.07 | 8.30 ± 0.33 | 8.13 ± 0.40 | 1.58 ± 0.05 | 1.52 ± 0.07 |
| (0.1% Tween 80) | (10)^{d} | (8) | (10) | (8) | (10) | (8) | (10) | (8) |
| HS-4-ME-IAA | 68.40 ± 5.39 | 18.11 ± 0.59 | 1.72 ± 0.05 | 1.45 ± 0.08 | 9.40 ± 0.34 | 9.00 ± 0.37 | 1.73 ± 0.04 | 1.67 ± 0.06 |
| 1 × 10⁻⁷M | (10) | (9) | (10) | (9) | (10) | (9) | (10) | (9) |
| (in 0.1% Tween 80) | | | | | | | | |
| HS-4-ME-IAA | 60.40 ± 5.23 | 16.71 ± 1.55 | 1.38 ± 0.08 | 1.19 ± 0.07 | 8.80 ± 0.29 | 8.29 ± 0.18 | 1.47 ± 0.05 | 1.43 ± 0.06 |
| 1 × 10⁻⁶M | (10) | (7) | (10) | (7) | (10) | (7) | (10) | (7) |
| (in 0.1% Tween 80) | | | | | | | | |
| HS-4-ME-IAA | 61.33 ± 4.13 | 16.00 ± 1.46 | 1.60 ± 0.08 | 1.33 ± 0.04 | 9.11 ± 0.26 | 8.83 ± 0.17 | 1.59 ± 0.06 | 1.56 ± 0.08 |
| 1 × 10⁻⁵M | (9) | (6) | (9) | (6) | (9) | (6) | (9) | (6) |
| (in 0.1% Tween 80) | | | | | | | | |
| HS-4-ME-IAA | 52.22 ± 4.26 | 17.00 ± 1.37 | 1.71 ± 0.06 | 1.44 ± 0.07 | 7.63 ± 0.46 | 7.00 ± 0.45 | 1.58 ± 0.09 | 1.6 ± 0.07 |
| 1 × 10⁻⁴M | (9) | (6) | (9) | (6) | (9) | (6) | (9) | (6) |
| (in 0.1% Tween 80) | | | | | | | | |

^{a}One treatment application applied to the entire plant to cover when the first flowering node was near or at anthesis approximately 16 hours prior to the initiation of the heat treatment.
^{b}HS = heat stress treatment. The heat stress treatment was imposed by moving plants to receive the heat stress into a growth chamber with the following light and temperature conditions for 4 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C.; photoperiod = 16 h light/8 h dark. The plants were returned to the original growth chamber maintained at 19° C./17° C. light/dark (16 hr photoperiod) after the heat stress treatment to develop to maturity.
^{c}Data are means ± SE.
^{d}number of samples used to calculate the mean and SE. The sample number represents the number of pods set at either the upper or lower floral positions on the inflorescence of the first flowering node from a total of 10 plants per treatment for all treatments except HS-4-ME-IAA 1× 10⁻⁵M and HS-4-ME-IAA 1 × 10⁻⁴M, where the total number of plants per treatment was 9.

TABLE P8
The length and diameter of the lower and upper peduncles and pedicels of the inflorescence with two pods at the second
flowering node of pea plants cv. ‘Carneval’ treated with 4-ME-IAA or control solutions when exposed to heat stress conditions.

| | Lower | Upper | Lower | Upper | Lower | Upper | Lower | Upper |
|---|---|---|---|---|---|---|---|---|
| Experiment 2 | Peduncle | Peduncle | Peduncle | Peduncle | Pedicel | Pedicel | Pedicel | Pedicel |
| 2^{nd} Flowering node | Length | Length | diameter | diameter | Length | Length | diameter | diameter |
| Treatment^{a} | (mm) | (mm) | (mm) | (mm) | (mm) | (mm) | (mm) | (mm) |
| HS^{b}-Control | 44.22 ± 3.76^{c} | 17.43 ± 0.75 | 1.55 ± 0.06 | 1.30 ± 0.05 | 8.22 ± 0.28 | 8.00 ± 0.22 | 1.65 ± 0.06 | 1.51 ± 0.05 |
| (0.1% Tween 80) | (9)^{d} | (7) | (9) | (7) | (9) | (7) | (9) | (7) |
| HS-4-ME-IAA | 62.00 ± 2.88 | 17.00 ± 0.73 | 1.69 ± 0.05 | 1.41 ± 0.05 | 8.78 ± 0.28 | 8.50 ± 0.22 | 1.69 ± 0.06 | 1.55 ± 0.07 |
| 1 × 10⁻⁷M | (9) | (6) | (9) | (6) | (9) | (6) | (9) | (6) |
| (in 0.1% Tween 80) | | | | | | | | |
| HS-4-ME-IAA | 47.10 ± 3.42 | 16.86 ± 1.01 | 1.28 ± 0.06 | 1.20 ± 0.07 | 8.80 ± 0.36 | 8.14 ± 0.14 | 1.47 ± 0.05 | 1.43 ± 0.04 |
| 1 × 10⁻⁶M | (10) | (7) | (10) | (7) | (10) | (7) | (10) | (7) |
| (in 0.1% Tween 80) | | | | | | | | |
| HS-4-ME-IAA | 47.11 ± 5.35 | 16.33 ± 0.82 | 1.58 ± 0.05 | 1.32 ± 0.04 | 8.11 ± 0.11 | 8.00 ± 0.29 | 1.68 ± 0.07 | 1.55 ± 0.06 |
| 1 × 10⁻⁵M | (9) | (9) | (9) | (9) | (9) | (9) | (9) | (9) |
| (in 0.1% Tween 80) | | | | | | | | |
| HS-4-ME-IAA | 40.33 ± 4.51 | 16.88 ± 1.52 | 1.63 ± 0.04 | 1.29 ± 0.04 | 7.56 ± 0.38 | 7.25 ± 0.25 | 1.56 ± 0.06 | 1.54 ± 0.05 |
| 1 × 10⁻⁴M | (9) | (8) | (9) | (8) | (9) | (8) | (9) | (8) |
| (in 0.1% Tween 80) | | | | | | | | |

^{a}One treatment application applied to the entire plant to cover when the first flowering node was near or at anthesis approximately 16 hours prior to the initiation of the heat treatment.
^{b}HS = heat stress treatment. The heat stress treatment was imposed by moving plants to receive the heat stress into a growth chamber with the following light and temperature conditions for 4 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C.; photoperiod = 16 h light/8 h dark. The plants were returned to the original growth chamber maintained at 19° C./17° C. light/dark (16 hr photoperiod) after the heat stress treatment to develop to maturity.
^{c}Data are means ± SE.
^{d}number of samples used to calculate the mean and SE. The sample number represents the number of pods set at either the upper or lower floral positions on the inflorescence of the second flowering node from a total of 10 plants per treatment for all treatments except HS-4-ME-IAA 1 × 10⁻⁵M and HS-4-ME-IAA 1 × 10⁻⁴M, where the total number of plants per treatment was 9.

TABLE P9
The length and diameter of the lower and upper peduncles and pedicels of the inflorescence with two pods at the third
flowering node of pea plants cv. ‘Carneval’ treated with 4-ME-IAA or control solutions when exposed to heat stress conditions.

| | Lower | Upper | Lower | Upper | Lower | Upper | Lower | Upper |
|---|---|---|---|---|---|---|---|---|
| Experiment 2 | Peduncle | Peduncle | Peduncle | Peduncle | Pedicel | Pedicel | Pedicel | Pedicel |
| 3^{rd} Flowering node | Length | Length | diameter | diameter | Length | Length | diameter | diameter |
| Treatment^{a} | (mm) | (mm) | (mm) | (mm) | (mm) | (mm) | (mm) | (mm) |
| HS^{b}-Control | 30.44 ± 3.86^{c} | 13.60 ± 0.81 | 1.35 ± 0.04 | 1.20 ± 0.08 | 7.78 ± 0.22 | 7.40 ± 0.24 | 1.49 ± 0.06 | 1.40 ± 0.07 |
| (0.1% Tween 80) | (9)^{d} | (5) | (9) | (5) | (9) | (5) | (9) | (5) |
| HS-4-ME-IAA | 46.13 ± 2.75 | 18.60 ± 0.98 | 1.61 ± 0.06 | 1.31 ± 0.07 | 8.13 ± 0.40 | 8.20 ± 0.37 | 1.70 ± 0.06 | 1.46 ± 0.11 |
| 1 × 10⁻⁷M | (8) | (5) | (8) | (5) | (8) | (5) | (8) | (5) |
| (in 0.1% Tween 80) | | | | | | | | |
| HS-4-ME-IAA | 34.50 ± 2.73 | 15.80 ± 1.11 | 1.33 ± 0.05 | 1.17 ± 0.03 | 7.90 ± 0.28 | 8.60 ± 0.24 | 1.43 ± 0.05 | 1.34 ± 0.04 |
| 1 × 10⁻⁶M | (10) | (5) | (10) | (5) | (10) | (5) | (10) | (5) |
| (in 0.1% Tween 80) | | | | | | | | |
| HS-4-ME-IAA | 39.22 ± 3.35 | 16.20 ± 1.74 | 1.52 ± 0.05 | 1.38 ± 0.09 | 7.67 ± 0.37 | 7.00 ± 0.32 | 1.58 ± 0.06 | 1.56 ± 0.08 |
| 1 × 10⁻⁵M | (9) | (5) | (9) | (5) | (9) | (5) | (9) | (5) |
| (in 0.1% Tween 80) | | | | | | | | |
| HS-4-ME-IAA | 28.22 ± 3.07 | 14.00 ± 1.00 | 1.53 ± 0.06 | 1.29 ± 0.03 | 7.33 ± 0.29 | 7.50 ± 0.29 | 1.55 ± 0.08 | 1.49 ± 0.05 |
| 1 × 10⁻⁴M | (9) | (4) | (9) | (4) | (9) | (4) | (9) | (4) |
| (in 0.1% Tween 80) | | | | | | | | |

^{a}One treatment application applied to the entire plant to cover when the first flowering node was near or at anthesis approximately 16 hours prior to the initiation of the heat treatment.
^{b}HS = heat stress treatment. The heat stress treatment was imposed by moving plants to receive the heat stress into a growth chamber with the following light and temperature conditions for 4 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C.; photoperiod = 16 h light/8 h dark. The plants were returned to the original growth chamber maintained at 19° C./17° C. light/dark (16 hr photoperiod) after the heat stress treatment to develop to maturity.
^{c}Data are means ± SE.
^{d}number of samples used to calculate the mean and SE. The sample number represents the number of pods set at either the upper or lower floral positions on the inflorescence of the third flowering node from a total of 10 plants per treatment for all treatments except HS-4-ME-IAA 1 × 10⁻⁵M and HS-4-ME-IAA 1 × 10⁻⁴M, where the total number of plants per treatment was 9.

TABLE P10
The length and diameter of the lower and upper peduncles and pedicels of the inflorescence with two pods at the fourth
flowering node of pea plants cv. ‘Carneval’ treated with 4-ME-IAA or control solutions when exposed to heat stress conditions.

| | Lower | Upper | Lower | Upper | Lower | Upper | Lower | Upper |
|---|---|---|---|---|---|---|---|---|
| Experiment 2 | Peduncle | Peduncle | Peduncle | Peduncle | Pedicel | Pedicel | Pedicel | Pedicel |
| 4^{th} Flowering node | Length | Length | diameter | diameter | Length | Length | diameter | diameter |
| Treatment^{a} | (mm) | (mm) | (mm) | (mm) | (mm) | (mm) | (mm) | (mm) |
| HS^{b}-Control | 25.00 ± 3.63^{c} | 16.00 ± 2.00 | 1.27 ± 0.07 | 1.17 ± 0.06 | 7.29 ± 0.36 | 7.50 ± 0.50 | 1.51 ± 0.07 | 1.46 ± 0.09 |
| (0.1% Tween 80) | (7)^{d} | (2) | (7) | (2) | (7) | (2) | (7) | (2) |
| HS-4-ME-IAA | 38.67 ± 3.18 | 17.00 ± 1.00 | 1.58 ± 0.06 | 1.30 ± 0.06 | 7.50 ± 0.56 | 8.00 ± 0.58 | 1.49 ± 0.05 | 1.39 ± 0.15 |
| 1 × 10⁻⁷M | (6) | (3) | (6) | (3) | (6) | (3) | (6) | (3) |
| (in 0.1% Tween 80) | | | | | | | | |
| HS-4-ME-IAA | 26.80 ± 4.55 | 15.00 | 1.25 ± 0.06 | 1.33 | 7.40 ± 0.24 | 8.00 | 1.49 ± 0.11 | 1.46 |
| 1 × 10⁻⁶M | (5) | (1) | (5) | (1) | (5) | (1) | (5) | (1) |
| (in 0.1% Tween 80) | | | | | | | | |
| HS-4-ME-IAA | 29.50 ± 2.63 | (0) | 1.39 ± 0.02 | (0) | 7.17 ± 0.48 | (0) | 1.41 ± 0.07 | (0) |
| 1 × 10⁻⁵M | (6) | | (6) | | (6) | | (6) | |
| (in 0.1% Tween 80) | | | | | | | | |
| HS-4-ME-IAA | 25.50 ± 3.97 | 14.50 ± 0.50 | 1.38 ± 0.10 | 1.17 ± 0.02 | 7.00 ± 0.41 | 7.00 ± 0.0 | 1.45 ± 0.11 | 1.33 ± 0.15 |
| 1 × 10⁻⁴M | (4) | (2) | (4) | (2) | (4) | (2) | (4) | (2) |
| (in 0.1% Tween 80) | | | | | | | | |

^{a}One treatment application applied to the entire plant to cover when the first flowering node was near or at anthesis approximately 16 hours prior to the initiation of the heat treatment.
^{b}HS = heat stress treatment. The heat stress treatment was imposed by moving plants to receive the heat stress into a growth chamber with the following light and temperature conditions for 4 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C.; photoperiod = 16 h light/8 h dark. The plants were returned to the original growth chamber maintained at 19° C./17° C. light/dark (16 hr photoperiod) after the heat stress treatment to develop to maturity.
^{c}Data are means ± SE.
^{d}number of samples used to calculate the mean and SE. The sample number represents the number of pods set at either the upper or lower floral positions on the inflorescence of the fourth flowering node from a total of 10 plants per treatment for all treatments except HS-4-ME-IAA 1 × 10⁻⁵M and HS-4-ME-IAA 1 × 10⁻⁴M, where the total number of plants per treatment was 9.

TABLE P11
Seed yield parameters of growth chamber grown pea ‘Carneval’
treated with 4-ME-IAA or control solutions.
Experiment 2

| | Ratio of | | | |
|---|---|---|---|---|
| | seed | | | |
| | number on | | | |
| | main stem | Seed | Seed | Weight per |
| | to lateral | number | weight per | seed |
| Treatment^{a} | stems | per plant | plant (g) | (g) |
| Control | 3.1 ± 0.5^{b} | 35.8 ± 4.5 | 8.7 ± 1.0 | 0.247 ± 0.007 |
| (0.1% Tween 80) | | | | |
| 4-ME-IAA | 3.0 ± 0.4 | 63.5 ± 6.8 | 15.5 ± 1.6 | 0.245 ± 0.004 |
| 1 × 10⁻⁷M | | | | |
| (in 0.1% Tween 80 | | | | |
| 4-ME-IAA | 2.9 ± 0.6 | 63.3 ± 4.6 | 14.9 ± 0.9 | 0.238 ± 0.006 |
| 1 × 10⁻⁶M | | | | |
| (in 0.1% Tween 80) | | | | |
| 4-ME-IAA | 3.3 ± 0.6 | 60.3 ± 3.2 | 14.0 ± 0.9 | 0.230 ± 0.004 |
| 1 × 10⁻⁵M | | | | |
| (in 0.1% Tween 80) | | | | |
| 4-ME-IAA | 4.6 ± 1.1 | 56.7 ± 3.6 | 14.0 ± 1.0 | 0.247 ± 0.006 |
| 1 × 10⁻⁴M | | | | |
| (in 0.1% Tween 80) | | | | |
| Early^{c} 4-ME-IAA | 1.6 ± 0.1 | 73.8 ± 5.9 | 18.2 ± 1.4 | 0.248 ± 0.006 |
| 1 × 10⁻⁶M | | | | |
| (in 0.1% Tween 80) | | | | |
| Early^{c} 4-ME-IAA | 1.5 ± 0.2 | 64.8 ± 5.2 | 16.2 ± 1.3 | 0.252 ± 0.006 |
| 1 × 10⁻⁵M | | | | |
| (in 0.1% Tween 80) | | | | |

^{a}One treatment application was applied to the entire plant to cover when the first flowering node was near or at anthesis.
^{b}Data are means ± SE, n = 10 plants except for Early 4-ME-IAA 1 × 10⁻⁵M and Early 4-ME-IAA 1 × 10⁻⁶M, where n = 8.
^{c}In the early treatment, one treatment application was applied to the entire plant to cover when the floral buds were tightly clustered inside the stipule leaves at the stem apex (floral buds not visible outside of stipule leaves), approximately 1.5 to 2 weeks prior to application when the first flowering node was near or at anthesis.

TABLE P12
Seed yield parameters of growth chamber grown pea
‘Carneval’ treated with 4-ME-IAA or control
solutions when exposed to heat stress conditions.
Experiment 2

| | Ratio of seed | | | |
|---|---|---|---|---|
| | number on | Seed | Seed | |
| | main stem to | number | weight per | Weight per |
| Treatment^{a} | lateral stems | plant | per plant (g) | seed (g) |
| HS^{b}-Control | 2.2 ± 0.5^{c} | 43.1 ± 4.4 | 11.9 ± 1.3 | 0.274 ± 0.005 |
| (0.1% | | | | |
| Tween 80) | | | | |
| HS-4-ME-IAA | 1.2 ± 0.2 | 55.9 ± 5.9 | 15.3 ± 1.7 | 0.273 ± 0.010 |
| 1 × 10⁻⁷M | | | | |
| (in 0.1% | | | | |
| Tween 80 | | | | |
| HS-4-ME-IAA | 2.0 ± 0.5 | 46.8 ± 3.3 | 12.9 ± 0.9 | 0.277 ± 0.005 |
| 1 × 10⁻⁶M | | | | |
| (in 0.1% | | | | |
| Tween 80) | | | | |
| HS-4-ME-IAA | 1.1 ± 0.1 | 50.6 ± 5.0 | 13.7 ± 1.2 | 0.274 ± 0.005 |
| 1 × 10⁻⁵M | | | | |
| (in 0.1% | | | | |
| Tween 80) | | | | |
| HS-4-ME-IAA | 2.1 ± 0.4 | 55.6 ± 6.2 | 14.5 ± 1.7 | 0.261 ± 0.009 |
| 1 × 10⁻⁴M | | | | |
| (in 0.1% | | | | |
| Tween 80) | | | | |

^{a}One treatment application applied to the entire plant to cover when the first flowering node was near or at anthesis approximately16 hours prior to the initiation of the heat treatment.
^{b}HS = heat stress treatment. The heat stress treatment was imposed by moving plants to receive the heat stress into a growth chamber with the following light and temperature conditions for 4 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C.; photoperiod = 16 h light/8 h dark. The plants were returned to the original growth chamber maintained at 19° C./17° C. light/dark (16 hr photoperiod) after the heat stress treatment to develop to maturity.
^{c}Data are means ± SE, n = 10 plants except for HS-4-ME-IAA 1 × 10⁻⁵M treatment, where n = 9.

### Example 2

### Canola

Canola seeds (Brassica napus) from the cultivar Peace were planted at an approximate depth of 1 cm in 5 inch square plastic pots (6 inch pot depth; 4 seeds per pot) in 1:1 Sunshine #4 potting mix (Sun Gro Horticulture, Vancouver, Canada) and sand. The seedlings were thinned to one seedling per pot approximately 2 weeks after seeding. Plants were grown at the University of Alberta in a greenhouse from Nov. 14, 2011 to Mar. 5, 2012. The average temperature was approximately 18° C. day/16° C. night (Nov. 14, 2011 to Feb. 8, 2012) then 21° C. day/19° C. night from Feb. 8 to Mar. 5, 2012. The plants also received supplemental lighting daily (average photon flux density of 250 μE m⁻²s⁻²) for 16 hours per day (from 6 am to 10 pm).

The auxins, 4-methyl-indole-3-acetic acid (4-ME-IAA) or 4-chloro-indole-3-acetic acid (4-Cl-IAA) at 1×10⁻⁷, 1×10⁻⁶, 1×10⁻⁵, or 1×10⁻⁴M in aqueous 0.1% (v/v) Tween 80 or a control solution (aqueous 0.1% [v/v] Tween 80) were applied one time as a foliar spray to canola plants at the green bud stage (BBCH scale 51; prior to bolting when flower buds are visible from above, but they are tightly clustered and have not extended above smallest leaves surrounding the inflorescence). The experiment was arranged in a completely randomized design in the greenhouse.

The heat stress treatment was imposed by moving plants to receive the heat stress from the greenhouse into a growth chamber for 6 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C. The photoperiod was 16 h light/8 h dark at an average photon flux density of 492 μE m⁻²s⁻² using 54W/835/HO high fluorescent bulbs, Phillips, Holland. This heat treatment cycle was imposed for 6 days. The plants were returned to the greenhouse after the heat stress treatment to develop to maturity.

One application of 4-ME-IAA applied to canola plants at the green bud stage increased the percent pod set from 17 to 25% at concentrations of 1×10⁻⁷ M to 1×10⁻⁵ M compared to the control (Table C1). The total number of pods with developing seeds per plant increased 10% and seed yield increased 22% when plants were treated with 4-ME-IAA at 1×10⁻⁷ M compared to the control (Table C1). When 4-ME-IAA was applied approximately 16 hrs prior to the heat stress treatment (6 hours at 33° C. per day for 6 days), similar to the non-heat stressed plants, the total number of pods with developing seeds per plant increased 13% with 4-ME-IAA treatment at 1×10⁻⁷ M compared to the control (Table C2). 4-ME-IAA at 1×10⁻⁵ M increased the total number of racemes per plant (38%) and total number of flowers per plant (43%) compared to the control; the mean seed yield for this hormone treatment was higher than the control, but an increase in seed yield was not significant (Table C2).

One application of 4-Cl-IAA applied at the green bud stage increased the percent pod set by 21% at the concentration of 1×10⁻⁷ M compared to the control (Table C3). The total number of pods with developing seeds per plant was increased with 4-Cl-IAA application at 1×10⁻⁷ M (18% higher) and 1×10⁻⁵ M (27% higher) when compared to the control (Table C3). The seed yield means for the 4-CL-IAA treatments at 1×10⁻⁷ M and 1×10⁻⁵ M were higher than the control mean, but an increase in seed yield for the hormone treatments compared to the control was not significant (Table C3). When 4-Cl-IAA was applied approximately 16 hrs prior to the mild heat stress treatment (6 hours at 33° C. per day for 6 days), the plants treated with 4-Cl-IAA at 1×10⁻⁷ M to 1×10⁻⁵ M tended to have on average a higher total number of pods with developing seeds per plant (Table 4), but the 4-Cl-IAA-treated plants were not statistically different from the control treatment for this parameter. 4-Cl-IAA at 1×10⁻⁶ M did significant increase seed yield in the plants exposed to the mild heat stress treatment (Table C4).

Although 4-Cl-IAA applied at 1×10⁻⁴ M to canola plants under non-stress conditions did not reduce the percent pod set, at this high concentration, the number of racemes per plant was reduced by 33% and this lead to a reduced total number of developing pods per plant (31%) and reduced seed yield (26%) when compared to the control (Table C3). The reduction in raceme number and seed yield did not occur when 4-Cl-IAA was applied at 1×10⁻⁴ M to canola plants approximately 16 hrs prior to the heat stress treatment (Table C4). This may be due to some degradation of the applied 4-Cl-IAA under the mild heat stress conditions. Indeed, leaf epinasty was observed 24 hours after 4-Cl-IAA and 4-ME-IAA treatment to the canola plants at the 1×10⁻⁴ M concentration, with the plants under heat stress conditions having milder leaf epinasty than the plants under non-stress conditions.

As applications of 4-ME-IAA and/or 4-Cl-IAA at specific concentrations increased the total number of pods with developing seeds per plant and seed yield in canola (Brassica napus) under both non-heat stress (Tables C1 and C3) and heat stress (Tables C2 and C4) environmental conditions, these data show that these auxins (4-ME-IAA and/or 4-Cl-IAA) have positive agronomic effects for increasing canola seed yield under both abiotic stress and non-stress environmental conditions.

TABLE C1
Effect of 4-ME-IAA treatment on reproductive parameters in canola cv.
Peace plants grown under non-heat stress conditions.^{a}

| | | | Total | | | |
|---|---|---|---|---|---|---|
| | Total | Total | number of | Total | | Seed |
| | number | number | pods with | number | | yield |
| | of | of | developing | undeveloped | % pod | (g) |
| | racemes | flowers | seeds per | pods per | set per | per |
| Treatment^{b} | per plant | per plant | plant | plant | plant | plant |
| Control | 12 ± 1^{c} | 301 ± 33 | 154 ± 8 | 34 ± 5 | 53 ± 3 | 4.5 ± 0.5 |
| (0.1% | | | | | | |
| Tween 80) | | | | | | |
| 4-ME-IAA | 10 ± 1 | 256 ± 12 | 170 ± 7 | 17 ± 3 | 66 ± 1 | 5.5 ± 0.4 |
| 1 × 10⁻⁷M | | | | | | |
| 4-ME-IAA | 10 ± 1 | 250 ± 21 | 155 ± 16 | 17 ± 5 | 62 ± 3 | na^{d} |
| (1 × 10⁻⁶M) | | | | | | |
| 4-ME-IAA | 10 ± 0 | 265 ± 14 | 165 ± 18 | 22 ± 6 | 62 ± 5 | 5.7 ± 0.7 |
| (1 × 10⁻⁵M) | | | | | | |
| 4-ME-IAA | 11 ± 1 | 261 ± 14 | 148 ± 9 | 16 ± 2 | 57 ± 2 | 4.9 ± 0.4 |
| (1 × 10⁻⁴M) | | | | | | |

^{a}Plants were grown in a greenhouse for approximately 3.5 months (Nov. 14, 2011 to Mar. 5, 2012) at approximately 18° C. day/16° C. night (Nov. 14, 2011 to Feb. 8, 2012) then 21° C. day/19° C. night from Feb. 8 to Mar. 5, 2012. The plants were exposed to 16 hours of supplemental lighting daily. Preharvest data (all data except seed yield) were taken from Feb. 7 to 15, 2012.
^{b}Hormone treatments: aqueous solutions of 4-ME-IAA (1 × 10⁻⁷ to 1 × 10⁻⁴M) in 0.1% Tween 80; one application sprayed on the canola plant at the 'green bud' stage (BBCH scale 51).
^{c}Data are means ± SE, n = 5; the unit of replication (n) is one plant.
^{d}not available.

TABLE C2
Effect of 4-ME-IAA treatment on reproductive parameters in canola cv. Peace
plants when exposed to heat stress conditions.^{a}

| | | | Total | | | |
|---|---|---|---|---|---|---|
| | Total | Total | number of | Total | | |
| | number | number | pods with | number | % | Seed |
| | of | of | developing | undeveloped | pod | yield |
| Treatment^{b} | racemes | flowers | seeds | pods | set | (g) |
| HS^{c}-Control | 13 ± 1^{d} | 364 ± 41 | 189 ± 16 | 32 ± 4 | 53 ± 3 | 5.3 ± 0.4 |
| (0.1% Tween | | | | | | |
| 80) | | | | | | |
| HS-4 -ME-IAA | 14 ± 1 | 418 ± 25 | 213 ± 6 | 50 ± 26 | 52 ± 4 | 5.4 ± 0.9 |
| (1 × 10⁻⁷M) | | | | | | |
| HS-4-ME-IAA | 13 ± 2 | 435 ± 89 | 167 ± 15 | 71 ± 37 | 44 ± 7 | na^{e} |
| (1 × 10⁻⁶M) | | | | | | |
| HS-4-ME-IAA | 18 ± 2 | 520 ± 102 | 259 ± 55 | 64 ± 13 | 50 ± 2 | 5.9 ± 1.2 |
| (1 × 10⁻⁵M) | | | | | | |
| HS-4-ME-IAA | 12 ± 1 | 326 ± 34 | 196 ± 19 | 34 ± 10 | 60 ± 1 | 6.0 ± 1.0 |
| (1 × 10⁻⁴M) | | | | | | |

^{a}Plants were grown in a greenhouse for approximately 3.5 months (Nov. 14, 2011 to Mar. 5, 2012) at approximately 18° C. day/16° C. night (Nov. 14, 2011 to Feb. 8, 2012) then 21° C. day/19° C. night from Feb. 8 to Mar. 5, 2012. The plants were exposed to 16 hours of supplemental lighting daily. Preharvest data (all data except seed yield) were taken from Feb. 7 to 15, 2012.
^{b}Hormone treatments: aqueous solutions of 4-ME-IAA (1 × 10⁻⁷ to 1 × 10⁻⁴M) in 0.1% Tween 80; one application sprayed on the plants 16 hours prior to the initiation of the heat treatment. All plants were treated with hormone solutions at the 'green bud' stage (BBCH scale 51).
^{c}HS = heat stress treatment. The heat stress treatment was imposed by moving plants to receive the heat stress from the greenhouse into a growth chamber for 6 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C.; photoperiod = 16 h light/8 h dark. This heat treatment cycle was imposed for 6 days. The plants were returned to the greenhouse after the heat stress treatment to develop to maturity.
^{d}Data are means ± SE, n = 5; the unit of replication (n) is one plant.
^{e}not available.

TABLE C3
Effect of 4-Cl-IAA treatment on reproductive parameters in canola cv. Peace
plants grown under non-heat stress conditions.^{a}

| | | | Total | | | |
|---|---|---|---|---|---|---|
| | Total | Total | number of | Total | | |
| | number | number | pods with | number | | Seed |
| | of | of | developing | undeveloped | % pod | yield |
| Treatment^{b} | racemes | flowers | seeds | pods | set | (g) |
| Control | 12 ± 1^{c} | 301 ± 33 | 154 ± 8 | 34 ± 5 | 53 ± 3 | 5.4 ± 0.6 |
| (0.1% Tween | | | | | | |
| 80) | | | | | | |
| 4-Cl-IAA | 10 ± 1 | 287 ± 29 | 181 ± 14 | 26 ± 9 | 64 ± 4 | 6.2 ± 0.6 |
| (1 × 10⁻⁷M) | | | | | | |
| 4-Cl-IAA | 12 ± 1 | 290 ± 26 | 174 ± 25 | 29 ± 4 | 59 ± 4 | na^{d} |
| (1 × 10⁻⁶M) | | | | | | |
| 4-Cl-IAA | 14 ± 2 | 362 ± 53 | 195 ± 21 | 47 ± 19 | 57 ± 6 | 5.8 ± 1.0 |
| (1 × 10⁻⁵M) | | | | | | |
| 4-Cl-IAA | 8 ± 1 | 201 ± 24 | 106 ± 8 | 17 ± 4 | 54 ± 4 | 4.0 ± 0.3 |
| (1 × 10⁻⁴M) | | | | | | |

^{a}Plants were grown in a greenhouse for approximately 3.5 months (Nov. 14, 2011 to Mar. 5, 2012) at approximately 18° C. day/16° C. night (Nov. 14, 2011 to Feb. 8, 2012) then 21° C. day/19° C. night from Feb. 8 to Mar. 5, 2012. The plants were exposed to 16 hours of supplemental lighting daily. Preharvest data (all data except seed yield) were taken from Feb. 7 to 15, 2012.
^{b}Hormone treatments: 4-Cl-IAA (1 × 10⁻⁷ to 1 × 10⁻⁴M) aqueous solutions in 0.1% Tween 80; Control solution aqueous 0.1 % Tween 80; one application sprayed on plant at the ‘green bud’ stage (BBCH scale 51).
^{c}Data are means ± SE, n = 5; the unit of replication (n) is one plant.
^{d}not available.

TABLE C4
Effect of 4-Cl-IAA treatment on reproductive parameters in canola cv. Peace
plants when exposed to heat stress conditions.^{a}

| | | | Total | | | |
|---|---|---|---|---|---|---|
| | Total | Total | number of | Total | | |
| | number | number | pods with | number | | Seed |
| | of | of | developing | undeveloped | % pod | yield |
| Treatment^{b} | racemes | flowers | seeds | pods | set | (g) |
| HS^{c}-Control | 13 ± 1^{d} | 364 ± 41 | 189 ± 17 | 32 ± 4 | 53 ± 3 | 5.2 ± 0.7 |
| (0.1% Tween | | | | | | |
| 80) | | | | | | |
| HS-4-Cl-IAA | 13 ± 2 | 443 ± 70 | 197 ± 15 | 43 ± 14 | 46 ± 3 | 6.0 ± 0.9 |
| (1 × 10⁻⁷M) | | | | | | |
| HS-4-Cl-IAA | 15 ± 1 | 430 ± 39 | 229 ± 30 | 42 ± 5 | 53 ± 3 | 6.8 ± 0.5 |
| (1 × 10⁻⁶M) | | | | | | |
| HS-4-Cl-IAA | 14 ± 2 | 414 ± 65 | 198 ± 33 | 34 ± 6 | 48 ± 2 | 5.5 ± 1.0 |
| (1 × 10⁻⁵M) | | | | | | |
| HS-4-Cl-IAA | 12 ± 1 | 312 ± 32 | 151 ± 17 | 45 ± 15 | 49 ± 4 | 4.9 ± 0.8 |
| (1 × 10⁻⁴M) | | | | | | |

^{a}Plants were grown in a greenhouse for approximately 3.5 months (Nov. 14, 2011 to Mar. 5, 2012) at approximately 18° C. day/16° C. night (Nov. 14, 2011 to Feb. 8, 2012) then 21° C. day/19° C. night from Feb.8 to Mar. 5, 2012. The plants were exposed to 16 hours of supplemental lighting daily. Preharvest data (all data except seed yield) were taken from Feb. 7 to 15, 2012.
^{b}Hormone treatments: aqueous solutions of 4-Cl-IAA (1 × 10⁻⁷ to 1 × 10⁻⁴M) in 0.1% Tween 80; Control solution aqueous 0.1 % Tween 80; one application sprayed on the plants 16 hours prior to the initiation of the heat treatment. All plants were treated with hormone solutions at the ‘green bud’ stage (BBCH scale 51).
^{c}HS = heat stress treatment. The heat stress treatment was imposed by moving plants to receive the heat stress from the greenhouse into a growth chamber for 6 days. The light cycle began at 7:00 hours at a 19° C. air temperature. The heat treatment began at 11:00 hours (33° C. air temperature) and was maintained for 6 hours (until 17:00 hours). Following the heat treatment, the remainder of the light cycle was maintained at a 22° C. air temperature. The dark cycle (began at 23:00 hours) was maintained at 17° C.; photoperiod = 16 h light/8 h dark. This heat treatment cycle was imposed for 6 days. The plants were returned to the greenhouse after the heat stress treatment to develop to maturity.
^{d}Data are means ± SE, n = 5; the unit of replication (n) is one plant.

### Example 3

### Wheat

The wheat (Triticum aestivum) cultivar Harvest HRS was seeded on May 20, 2011 with a target of 250 seedlings per m² into a field plot located at the St. Albert Field-Research Station of the University of Alberta, St. Albert, Alberta, Canada that was seeded with canola the previous season. Eight 2×4 m plots were cut out of a larger field plot with a mower producing two rows of four 2×4 m plots with a 1 m buffer between each plot and 4 m between the 4-plot rows. The hormone treatments were randomly assigned to the 2×4 plots. Aqueous solutions of 4-ME-IAA at 1×10⁻⁵ M in 0.1% (v/v) Tween 80 or control solutions (0.1% [v/v]Tween 80) were sprayed Jul. 15, 2011 in slightly breezy (8 km/h), overcast weather, temperature 16° C. Three hours later, the sun emerged and the ambient temperature rose from 16° C. to 21° C. The relative humidity at the time of spraying was 75%. On average, 15% of the plants in the plots had their first florets open at the time of hormone application. A separate Chapin 20000-type 4 L pneumatic sprayer was used for applying the 4-ME-IAA and the control solutions; each sprayer was equipped with a medium-delivery blue fan nozzle designed to deliver 1.4 L per minute at the normal operating pressure of 40 PSI. Each plot was sprayed with a total of 0.91 L of solution to obtain uniform coverage.

In another experiment, seeds of the wheat cultivar Harvest HRS were planted at an approximate depth of 1.5 cm in 5 inch square plastic pots (6 inch pot depth; 3 seeds per pot) in 1:1 Sunshine #4 potting mix (Sun Gro Horticulture, Vancouver, Canada) and sand. The seedlings were thinned to one seedling per pot approximately 2 weeks after seeding. Plants were grown in a Conviron growth chamber maintained at 24° C. light/20° C. dark (16 hours light/8 hours dark photoperiod; using 54W/835/HO high fluorescent bulbs [Phillips, Holland] with an average photon flux density of 540 μE m⁻²s⁻². Plant were fertilized with 175 ppm 20-20-20 (N:P:K) every 3 to 4 days.

Aqueous solutions of 4-ME-IAA at 1×10⁻⁶, 1×10⁻⁵, or 1×10⁻⁴ M in 0.1% (v/v) Tween 80 or a control solution (0.1% [v/v] Tween 80) were applied (sprayed on plant to cover) when the majority of the plants were at the BBCH scale 45 developmental stage (late boot stage where the flag leaf sheath [boot] is swollen with the inflorescence, but the inflorescence has not emerged from the boot). The experiment was arranged in a completely randomized design within the growth chamber.

The heat stress treatment was imposed by moving plants to receive the heat stress to a different growth chamber ((heat stress chamber) for 6 days. In the heat stress chamber, the light cycle began at 7:00 hours at a 24° C. air temperature. The heat treatment began at 11:00 hours (33° C. air temperature) and was maintained for 6 hours (until 17:00 hours). Following the heat treatment, the remainder of the light cycle was maintained at a 24° C. air temperature. The dark cycle (began at 23:00 hours) was maintained at 20° C. The photoperiod was 16 h light/8 h dark at an average photon flux density of 492 μE m⁻²s⁻² using 54W/835/HO high fluorescent bulbs (Phillips, Holland). After 6 days, the heat stress-treated plants were returned to the original growth chamber maintained at non-heat stress conditions to develop to maturity.

In the wheat field experiment, plant height and number of floral spikes per plant were not affected by the 4-ME-IAA treatment (1×10⁻⁵M) when application was at 15% first floret opening for ‘Harvest HRS’ (Table W1). Seed weight per floral spike and seed number per floral spike increased by 12% and 10%, respectively, with 4-ME-IAA treatment (1×10⁻⁵M) (Table W1). These data show positive agronomic effects of 4-ME-IAA for increasing wheat seed yield in the field.

When ‘Harvest HRS’ was grown in a growth chamber the plants produced markedly higher numbers of floral spikes with less seeds per spike compared to under field conditions (controls; Tables W1 and W2). This is most likely due to the different environmental conditions in the field compared to that in the growth chamber. When plants were exposed to 6 hours of 33° C. for 6 days (mild heat stress conditions) at the late boot stage when the flag leaf sheath (boot) was swollen with the inflorescence, the elongation of the floral spike peduncle was inhibited compared to those grown under non-heat stress conditions (controls; Tables W2 and W3). Application of 4-ME-IAA at 1×10⁻⁶ M and 1×10⁻⁴M to plants prior to exposure to heat stress conditions significantly increased the seed number per plant (101% and 73%, respectively) and seed weight per plant (90% and 72%, respectively) compared to the control (Table W3). 4-ME-IAA application at 1×10⁻⁶M also reversed the heat stress-induced inhibition of peduncle length and increased the number of floral spikes per plant by 40% compared to the control (Table W3). As application of 4-ME-IAA at specific concentrations increased the seed number per plant and seed weight per plant in wheat (Triticum aestivum) when applied to the plant prior to mild heat stress conditions, these data demonstrate that 4-ME-IAA has positive agronomic effects for increasing wheat seed yield under heat stress environmental conditions.

TABLE W1
Plant height, number of spikes (inflorescences) per plant, and seed yield of
field grown wheat ‘Harvest HRS’-Spring hard-red treated with 4-ME-IAA or control
solutions.

| | Pre-harvest^{a} | | At maturity^{b} | | | |
|---|---|---|---|---|---|---|
| | Number | | Total | | Seed | |
| | of | Plant | seed | Total | weight | Seed |
| | spikes per | height | weight | seed | per | number |
| Treatment | plant | (cm)^{c} | (g) | number | spike (g) | per spike |
| Control | 3.775 ± 0.109^{d} | 94.1 ± 0.8 | 18.4 ± 0.4 | 502.8 ± 18.8 | 0.92 ± 0.02 | 25.1 ± 0.9 |
| (0.1% Tween 80) | | | | | | |
| 4-ME-IAA | | | | | | |
| 1 × 10⁻⁵M | 3.825 ± 0.207 | 94.5 ± 0.4 | 20.6 ± 1.1 | 550.8 ± 26.6 | 1.03 ± 0.05 | 27.5 ± 1.3 |
| (in 0.1% Tween | | | | | | |
| 80) | | | | | | |

^{a}Based on 20 randomly selected plants per plot (measured on Aug. 15, 2011); Mean BBCH score was 85 throughout all plots.
^{b}Based on 20 randomly selected spikes per plot on Sep. 3, 2011.
^{c}stem at ground level to awn tip of highest spike
^{d}SE, standard error of the mean, n = 4 (2 × 4 m) plots.

TABLE W2
Length of spike peduncles, number of spikes (inflorescences) per
plant and seed yield of growth chamber grown ‘Harvest
HRS’-Spring hard-red wheat treated with 4-ME-IAA
or control solutions, under non-heat stress conditions.^{a}

| | Length of | | Seed | | |
|---|---|---|---|---|---|
| | spike | Number of | number | Seed | Seed |
| | peduncle | spikes per | per | number | weight per |
| Treatment^{b} | (mm) | plant | spike | per plant | plant (g) |
| Control | 73 ± 10^{c} | 20 ± 2 | 11 ± 2 | 232 ± 67 | 7.16 ± 1.96 |
| (0.1% | | | | | |
| Tween 80) | | | | | |
| 4-ME-IAA | 63 ± 6 | 24 ± 3 | 10 ± 2 | 254 ± 81 | 8.17 ± 2.66 |
| 1 × 10⁻⁶M | | | | | |
| (in 0.1% | | | | | |
| Tween 80) | | | | | |
| 4-ME-IAA | 82 ± 7 | 22 ± 3 | 12 ± 1 | 256 ± 42 | 7.56 ± 1.36 |
| 1 × 10⁻⁵M | | | | | |
| (in 0.1% | | | | | |
| Tween 80) | | | | | |
| 4-ME-IAA | 62 ± 5 | 25 ± 1 | 7 ± 1 | 163 ± 32 | 4.87 ± 0.95 |
| 1 × 10⁻⁴M | | | | | |
| (in 0.1% | | | | | |
| Tween 80) | | | | | |

^{a}Plants were grown in a growth chamber maintained at 24° C. light/20° C. dark (16 hours light/8 hours dark photoperiod; using 54W/835/HO high fluorescent bulbs (Philips, Holland) with an average photon flux density of 540 μE m⁻²s⁻²).
^{b}Hormone treatments: aqueous solutions of 4-Cl-IAA (1 × 10⁻⁶ to 1 × 10⁻⁴M) in 0.1% Tween 80; Control solution aqueous 0.1% Tween 80; one application sprayed on plant to cover when the majority of the plants were at the BBCH scale 45 developmental stage (late boot stage where the flag leaf sheath [boot] is swollen with the inflorescence, but the inflorescence has not emerged from the boot).
^{c}Data are means ± SE, n = 7; the unit of replication (n) is one plant.

TABLE W3
Length of spike peduncles, number of spikes (inflorescences) per plant
and seed yield of growth chamber grown ‘Harvest HRS’-Spring
hard-red wheat treated with 4-ME-IAA or control solutions and
subjected to 6 days of heat stress conditions.^{a}

| | | Number | | | |
|---|---|---|---|---|---|
| | Length of | of | Seed | Seed | |
| | spike | spikes | number | number | Seed |
| | peduncle | per | per | per | weight per |
| Treatment^{b} | (mm) | plant | spike | plant | plant (g) |
| HS^{c}-Control | 54 ± 7^{d} | 20 ± 3 | 3 ± 1 | 75 ± 19 | 2.37 ± 0.58 |
| (0.1% | | | | | |
| Tween 80) | | | | | |
| HS-4-ME-IAA | 72 ± 7 | 28 ± 3 | 5 ± 1 | 151 ± 43 | 4.49 ± 1.25 |
| 1 × 10⁻⁶M | | | | | |
| (in 0.1% | | | | | |
| Tween 80) | | | | | |
| HS-4-ME-IAA | 57 ± 5 | 24 ± 4 | 3 ± 1 | 57 ± 18 | 1.83 ± 0.57 |
| 1 × 10⁻⁵M | | | | | |
| (in 0.1% | | | | | |
| Tween 80) | | | | | |
| HS-4-ME-IAA | 70 ± 10 | 25 ± 3 | 5 ± 1 | 130 ± 23 | 4.08 ± 0.67 |
| 1 × 10⁻⁴M | | | | | |
| (in 0.1% | | | | | |
| Tween 80) | | | | | |

^{a}Plants were grown in a growth chamber maintained at 24° C. light/20° C. dark (16 hours light/8 hours dark photoperiod; using 54W/835/HO high fluorescent bulbs (Philips, Holland) with an average photon flux density of 540 μE m⁻²s⁻²).
^{b}Hormone treatments: aqueous solutions of 4-Cl-IAA (1 × 10⁻⁶ to 1 × 10⁻⁴M) in 0.1% Tween 80; Control solution aqueous 0.1% Tween 80; one application sprayed on the plants to cover 16 hours prior to the initiation of the heat treatment when the majority of the plants were at the BBCH scale 45 developmental stage (late boot stage where the flag leaf sheath [boot] is swollen with the inflorescence, but the inflorescence has not emerged from the boot).
^{c}HS = heat stress treatment. The heat stress treatment was imposed by moving plants to receive the heat stress to a different growth chamber (heat stress chamber) for 6 days. In the heat stress chamber, the light cycle began at 7:00 hours at a 24° C. air temperature. The heat treatment began at 11:00 hours (33° C. air temperature) and was maintained for 6 hours (until 17:00 hours). Following the heat treatment, the remainder of the light cycle was maintained at a 24° C. air temperature. The dark cycle (began at 23:00 hours) was maintained at 20° C.; photoperiod was 16 h light/8 h dark. After 6 days, the heat stress-treated plants were returned to the original growth chamber maintained at non-heat stress conditions to develop to maturity.
^{d}Data are means ± SE, n = 7; the unit of replication (n) is one plant.

### Example 4

### Tank Mixing with Herbicides or Fungicides

The following tables provide examples of possible tank mixes of an auxin or auxin analogue mixed with a herbicide or fungicide, for crop application.

TABLE TM1
Examples of auxin and auxin analogue tank mixes with herbicides and
fungicides for use on Pisum sativum L.

| | | Herbicide | Proposed | |
|---|---|---|---|---|
| | | or | crop | Example of some diseases or |
| | Auxin or auxin | fungicide | staging for | weeds that the herbicide or |
| | analogue | application | tank mix | fungicide is registered to |
| Tank Mix | application rate | rate | application | control in Pisum sativum L. |
| Bravo ® 500^{a} + | 3.4 mg to | 0.8 L/acre | 10% flower | Ascochyta blight |
| 4-Me-IAA | 3.4 g/acre | | | (Mycospharella pinodes) |
| Bravo ® 500 + | 3.8 mg to | 0.8 L/acre | 10% flower | Ascochyta blight |
| 4-Cl-IAA | 3.8 g/acre | | | (Mycospharella pinodes) |
| Quadris ®^{b} + | 3.4 mg to | 202 mL/acre | 10% flower | Asochyta blight (Ascochyta |
| 4-Me-IAA | 3.4 g/acre | | | spp.), Mycosphaerella blight |
| | | | | (Mycosphaerella pinodes), |
| | | | | powdery mildew (Erysiphe |
| | | | | pisi) |
| Quadris ® + | 3.8 mg to | 202 mL/acre | 10% flower | Asochyta blight (Ascochyta |
| 4-Cl-IAA | 3.8 g/acre | | | spp.), Mycosphaerella blight |
| | | | | (Mycosphaerella pinodes), |
| | | | | powdery mildew (Erysiphe |
| | | | | pisi) |
| Equinox ®^{c} + | 3.4 mg to | 101 mL/acre | 9 leaf stage | Green foxtail, wild oats, |
| 4-Me-IAA | 3.4 g/acre | | | Clearfield wheat, volunteer |
| | | | | oats |
| Equinox ® + | 3.8 mg to | 101 mL/acre | 9 leaf stage | Green foxtail, wild oats, |
| 4-Cl-IAA | 3.8 g/acre | | | volunteer wheat, volunteer |
| | | | | Clearfield wheat, volunteer |
| | | | | oats |
| Select ®^{d} + | 3.4 mg to | 152 mL/acre | 10% flower | Green foxtail, volunteer |
| 4-Me-IAA | 3.4 g/acre | | | cereals, wild oats, yellow |
| | | | | foxtail, barnyard grass |
| Select ® + | 3.8 mg to | 152 mL/acre | 10% flower | Green foxtail, volunteer |
| 4-Cl-IAA | 3.8 g/acre | | | cereals, wild oats, yellow |
| | | | | foxtail, barnyard grass |

^{a}The active ingredient in Bravo 500 is 500 g/L of Chlorothalonil;
^{b}The active ingredient in Quadris is 250 g/L of Azoxystrobin;
^{c}The active ingredient in Equinox is 200 g/L of Tepraloxydim;
^{d}The active ingredient in Select is 240 g/L of Clethodim.

TABLE TM2
Examples of auxin and auxin analogue tank mixes with herbicides and
fungicides for use on Canola (Brassica napus)

| | Auxin or | | Proposed | |
|---|---|---|---|---|
| | auxin | Herbicide | crop staging | Example of some diseases |
| | analogue | or fungicide | for tank | or weeds that the herbicide |
| | application | application | mix | or fungicide is registered to |
| Tank Mix | rate | rate | application | control in Brassica napus |
| Tilt ®^{a} + | 3.4 mg to | 202 mL/acre | 6 leaf | Blackleg |
| 4-Me-IAA | 3.4 g/acre | | rosette state | |
| Tilt ® + | 3.8 mg to | 202 mL/acre | 6 leaf | Blackleg |
| 4-Cl-IAA | 3.8 g/acre | | rosette state | |
| Quadris ®^{b} + | 3.4 mg to | 202 mL/acre | 6 leaf | Virulent blackleg, |
| 4-Me-IAA | 3.4 g/acre | | rosette state | Sclerotinia stem rot, |
| | | | | Alternaria black spot |
| Quadris ® + | 3.8 mg to | 202 mL/acre | 6 leaf | Virulent blackleg, |
| 4-Cl-IAA | 3.8 g/acre | | rosette state | Sclerotinia stem rot, |
| | | | | Alternaria black spot |
| Select ®^{c} + | 3.4 mg to | 152 mL/acre | 6 leaf | Green foxtail, volunteer |
| 4-Me-IAA | 3.4 g/acre | | rosette state | cereals, wild oats, yellow |
| | | | | foxtail, barnyard grass |
| Select ® + | 3.8 mg to | 152 mL/acre | 6 leaf | Green foxtail, volunteer |
| 4-Cl-IAA | 3.8 g/acre | | rosette state | cereals, wild oats, yellow |
| | | | | foxtail, barnyard grass |
| Glyphosate^{d} + | 3.4 mg to | 0.33 L/acre | 6 leaf | Volunteer cereals, redroot |
| 4-Me-IAA | 3.4 g/acre | | rosette state | pigweed, wild mustard, |
| | | | | kochia, hemp-nettle, |
| | | | | cleavers, wild buckwheat |
| Glyphosate + | 3.8 mg to | 0.33 L/acre | 6 leaf | Volunteer cereals, redroot |
| 4-Cl-IAA | 3.8 g/acre | | rosette state | pigweed, wild mustard, |
| | | | | kochia, hemp-nettle, |
| | | | | cleavers, wild buckwheat |

^{a}The active ingredient in Tilt is 250 g/L of Propiconazole;
^{b}The active ingredient in Quadris is 250 g/L of Azoxystrobin;
^{c}The active ingredient in Select is 240 g/L of Clethodim;
^{d}The rate of Glyphosate is 540 g/L .

TABLE TM3
Examples of auxin and auxin analogue tank mixes with herbicides and
fungicides for use on wheat (Triticum spp.)

| | Auxin or | | Proposed | |
|---|---|---|---|---|
| | auxin | Herbicide | crop staging | Example of some diseases |
| | analogue | or fungicide | for tank | or weeds that the herbicide |
| | application | application | mix | or fungicide is registered to |
| Tank Mix | rate | rate | application | control in Triticum spp. |
| Bravo ® 500^{a} + | 3.4 mg to | 0.8 L/acre | Flag leaf | Septoria leaf spot, Septoria |
| 4-Me-IAA | 3.4 g/acre | | | glume blotch, Tan spot |
| Bravo ® 500 + | 3.8 mg to | 0.8 L/acre | Flag leaf | Septoria leaf spot, Septoria |
| 4-Cl-IAA | 3.8 g/acre | | | glume blotch, Tan spot |
| Tilt ®^{b} + | 3.4 mg to | 202 mL/acre | Stem | Septoria leaf spot, Septoria |
| 4-Me-IAA | 3.4 g/acre | | Elongation | glume blotch, Powdery |
| | | | | mildew, Leaf Rust, Stem |
| | | | | Rust, Tan spot, Stripe Rust |
| Tilt ® + | 3.8 mg to | 202 mL/acre | Stem | Septoria leaf spot, Septoria |
| 4-Cl-IAA | 3.8 g/acre | | Elongation | glume blotch, Powdery |
| | | | | mildew, Leaf Rust, Stem |
| | | | | Rust, Tan spot, Stripe Rust |
| Refine ®^{c} + | 3.4 mg to | 12 g/acre | Flag leaf | Redroot pigweed, volunteer |
| 4-Me-IAA | 3.4 g/acre | | | canola (excluding Clearfield |
| | | | | varieties), wild buckwheat, |
| | | | | wild mustard |
| Refine ® + | 3.8 mg to | 12 g/acre | Flag leaf | Redroot pigweed, volunteer |
| 4-Cl-IAA | 3.8 g/acre | | | canola (excluding Clearfield |
| | | | | varieties), wild buckwheat, |
| | | | | wild mustard |

^{a}The active ingredient in Bravo 500 is 500 g/L of Chlorothalonil;
^{b}The active ingredient in Tilt is 250 g/L of Propiconazole;
^{c}The active ingredients in Refine are 33.35% Thifensulfuron methyl and 16.65% tribenuron methyl.

Other examples of suitable pesticides include Inspire® (difenconazole), which may be applied at about 250 g/l, and premixes of pesticides such as Quilt® which is a premix of Quadris (azoxystrobin) and Tilt (propiconazole).

### REFERENCES

The following references are incorporated herein by reference (where permitted) as if reproduced in their entirety. All references are indicative of the level of skill of those skilled in the art to which this invention pertains.
Biochemistry & Molecular Biology of the Plant (2000); eds. Buchanan, Gruissem, Jones, pp. 558-562; and 850-929.
Reinecke, D. M. (1999) 4-Chloroindole-3-acetic acid and plant growth. Plant Growth Regul 27:3-13.
Davies P J (2004) The plant hormones: Their nature, occurrence and function. (Davies P J (ed.) Plant Hormones: Biosynthesis, Signal Transduction, Action! 3^{rd} ed. Springer, Dordrecht, The Netherlands, p 1-15.
Ozga J A, Yu J, Reinecke D M (2003) Pollination-, development-, and auxin-specific regulation of gibberellin 3b-hydroxylase gene expression in pea fruits and seeds. Plant Physiol 131: 1137-1146.
Ozga J A, Reinecke D M, Ayele B T, Ngo P, Nadeau C D, Wickramarathna A D (2009).
O'Neill D P and Ross J J (2002) Auxin regulation of the gibberellin pathway in pea. Plant Physiol 130:1974-1982.
Serrani J C, Ruiz-Rivero O, Fos M, Garcí a-Martínez J L (2008) Auxin-induced fruit-set in tomato is mediated in part by gibberellins. Plant Journal 56:922-934.
Eeuwens C J, and Schwabe W W (1975) Seed and pod wall development in Pisum sativum L. in relation to extracted and applied hormones. J Exp Bot 26:1-14.
Sponsel (1982) Effects of applied gibberellins and naphthylacetic acid on pod development in fruits of Pisum sativum L. cv. Progress No. 9. J Plant Growth Regul 1:147-152.
Ozga J A, Brenner M L, Reinecke D M. (1992). Seed effects on gibberellin metabolism in pea pericarp. Plant Physiol 100:88-94.
Reinecke D M, Ozga J A, Magnus V (1995) Effect of halogen substitution of indole-3-acetic acid on biological activity in pea fruit. Phytochemistry 40: 1361-1366.
Rodrigo M J, Garcia-Martinez J L, Santes C M, Gaskin P, Hedden P (1997) The role of gibberellins A₁ and A₃ in fruit growth of Pisum sativum L. and the identification of gibberellins A₄ and A₇ in young seeds. Planta 201:446-455.
Müntz K, Rudolph A, Schlesier G, Silhengst P (1978) The function of the pericarp in fruits of crop legumes. Kulturpflanze 26:37-67
Nitsch J P (1970) Hormonal factors in growth and development. In: Hulme A C, editor. The biochemistry of fruits and their products. London and NY: Academic Press, p 427-472.
Cox, C M, and Swain, S M (2006) Localised and non-localised promotion of fruit development by seeds in Arabidopsis. Funct. Plant Biol. 33: 1-8
Gillaspy G, Ben-David H, Gruissem W (1993) Fruits: a developmental perspective. Plant Cell 5:1439-1451.
Magnus V, Ozga J A, Reinecke D M, Pierson G L, Larue T A, Cohen J D, Brenner M L. (1997) 4-cl-indole-3-acetic acid in Pisum sativum. Phytochemistry 46: 675-681.
Ozga J A and Reinecke D M (1999) Interaction of 4-cloroindole-3-acetic acid and gibberellins in early pea fruit development. Plant Growth Regul 27:33-38.
Molecular properties of 4-substituted indole-3-acetic acids affecting pea pericarp elongation, Reinecke et al., Plant Growth Regulation, Vol 27, No. 1, 39-48.
van Huizen R, Ozga J A, Reinecke D M (1997) Seed and hormonal regulation of gibberellin 20-oxidase expression in pea pericarp. Plant Physiol 115:123-128.
Dorcey E, Urbez C, Blazquez M A, Carbonell J, Perez-Amador M A (2009). Fertilization-dependent auxin response in ovules triggers fruit development through the modulation of gibberellin metabolism in Arabidopsis. Plant Journal (2009) 58:318-332.
Winnacker-Kuchler, “Chemische Technologie” [Chemical Technology], Volume 7, C. HauserVerlag, Munich, 4th Edition 1986.
Wade van Valkenburg, “Pesticide Formulations”, Marcel Dekker, N.Y., 1973.
K. Martens, “Spray Drying Handbook”, 3rd Ed. 1979, G. Goodwin Ltd. London.
Watkins, “Handbook of Insecticide Dust Diluents and Carriers”, 2nd Ed., Darland Books, Caldwell N.J.
H. v. Olphen, “Introduction to Clay Colloid Chemistry”, 2nd Ed., J. Wiley & Sons, N.Y.
C. Marsden, “Solvents Guide”, 2nd Ed., Interscience, N.Y. 1963.
McCutcheon's “Detergents and Emulsifiers Annual”, MC Publ. Corp., Ridgewood N.J.
Sisley and Wood, “Encyclopedia of Surface Active Agents”, Chem. Publ. Co. Inc., N.Y. 1964.
Schonfeldt, “Grenzflachenaktive Athylenoxidaddukte” [Surface-active ethylene oxide adducts], Wiss. Verlagsgesell., Stuttgart 1976.
Winnacker-Kuchler, “Chemische Technologie” [Chemical Technology], Volume 7, C. Hauser Verlag, Munich, 4th Ed. 1986.
“Spray-Drying Handbook” 3rd ed. 1979, G. Goodwin Ltd., London; J. E. Browning. “Agglomeration”, Chemical and Engineering 1967, pages 147 et seq.
G. C. Klingman, “Weed Control as a Science”, John Wiley and Sons, Inc., New York, 1961, pages 81-96.
J. D. Freyer, S. A. Evans, “Weed Control Handbook”, 5th Ed., Blackwell Scientific Publications, Oxford, 1968, pages 101-103.

1.-22. (canceled)

23. A method of enhancing plant growth in a flowering plant comprising an auxin response pathway, comprising applying, at or before an early reproductive stage of the plant, an effective amount of a composition comprising an auxin or auxin analog to the plant, or a portion thereof, or a locus thereof.

24. The method of claim 23, wherein the plant is selected from the group consisting of a plant from the Leguminosae (Fabaceae) family, a plant from the Brassicaceae (Cruciferae) family, a fruiting vegetable plant, and a crop plant in the Poaceae (Gramineae) family.

25. The method of claim 24, wherein the plant is selected from the group consisting of soybean, pea, canola, tomato and wheat plants.

26. The method of claim 23, wherein the composition is applied at anthesis or least one day prior to anthesis.

27. The method of claim 23, wherein the composition is applied at least one week prior to anthesis.

28. The method of claim 23, wherein the plant is a soybean or pea plant, and the composition is applied at or before anthesis.

29. The method of claim 28, wherein the composition is applied at a time when floral buds are not visible outside of stipule leaves.

30. The method of claim 24, wherein the plant is a plant from the Brassicaceae (Cruciferae) family, and the composition is applied at or before a green bud stage.

31. The method of claim 24, wherein the plant is a plant from the Poaceae (Gramineae) family, and the composition is applied at or before a late boot stage, where the inflorescence has not emerged from the boot, or where the inflorescence recently has emerged from the boot.

32. The method of claim 23, wherein the auxin or auxin analog comprises a 4-substituted indole-3-acetic acid.

33. The method of claim 32, wherein the auxin or auxin analog comprises 4-methyl-indole-3-acetic acid.

34. The method of claim 32, wherein the auxin or auxin analog comprises 4-chloro-indole-3-acetic acid.

35. The method of claim 23, wherein the composition further comprises one or more selected from the group consisting of insecticides, acaricides, herbicides, fungicides, safeners, fertilizers, and additional plant growth regulators.

36. The method of claim 35, wherein the composition further comprises one or more of a cytokinin and a gibberellin.

37. The method of claim 23, wherein the auxin or auxin analog is applied at a concentration from about 1×10⁻⁴ to about 1×10⁻⁷ M in aqueous solution.

38. The method of claim 23, wherein the composition is applied to a crop at a rate of about 0.0001 to 20 g/hectare.

39. The method of claim 23, wherein the composition is applied to a crop at a rate of about 3.4 mg to about 3.8 g per acre.

40. The method of claim 23, wherein the method ameliorates symptoms of abiotic stress in the plant.

41. The method of claim 40, wherein the abiotic stress comprises one or more selected from the group consisting of drought, salinity, and temperature (heat or cold) stress.

42. The method of claim 40, wherein the plant exhibits a plant growth response increase or benefit of 10% or more.

43. The method of claim 23, wherein the plant exhibits increased fruit or seed yield.

44. The method of claim 43, wherein the fruit or seed yield is increased by 10% of more.
